(19) United States
(12) Patent Application Publication
(10) Pub. No.: US 2006/0239144 A1
(43) Pub. Date: Oct. 26, 2006

(54) Access method, access device, information recording medium

(76) Inventors: Yoshiho Gotoh, Osaka-shi (JP); Hideaki Mita, Kobe-shi (JP); Masafumi Shimotashiro, Katano-shi (JP); Tasushi Bannai, Sakai-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/526,651

(22) PCT Filed: Sep. 1, 2003
(86) PCT No.: PCT/JP03/11177

§ 371 Date: May 9, 2006

(30) Foreign Application Priority Data
Sep. 6, 2002 (JP) JP2002-261577
Oct. 4, 2002 (JP) JP2002-292162

(51) Int. Cl. G11B 5/09

(52) U.S. Cl. 369/47.27

(57) ABSTRACT

A method for accessing an information recording medium in which a data area is allocated is provided. First file management information which provides a first access method and second file management information which provides a second access method are recorded in the information recording medium. The first file management information and the second file management information manage files recorded in the information recording medium. The method of the present invention comprises the steps of: (a) reading out one of the first file management information and the second file management information; and (b) accessing the data area with the access method provided by one of the read out first file management information and the read out second file management information.

### TECHNICAL FIELD

The present invention relates to a method for accessing information recording media with a first access method provided by first file management information and a second access method provided by second file management information, and information recording media on which the first file management information and the second file management information are recorded.

### BACKGROUND ART

Various information recording media (for example, DVD-Video, DVD-RAM, or the like) employs a file system having Universal Disc Format™ (hereinafter, referred to as UDF) issued by Optical Storage Technology Association (OSTA). By employing a UDF file system, data recording/reproduction on/from information recording media is implemented without being dependent on compatibility between equipments using the information recording media or types of media. UDF is a specification to implement compliant with ECMA167. UDF file systems are used in sophisticated equipments such as personal computers.

UDF file structures include data structures having a sector format. They are recorded in volume spaces allocated in information recording media. Thus, there is no limit for a record position for management information of file. Accordingly, they are suitable for recording general-purpose files (for example, for recording a large number of files) (Standard ECMA-167 3rd Edition, June 1997; and ECMA, Standardizing Information and Communication Systems, see <http://www.ecma.ch>).

However, for reproduction apparatuses to reproduce data recorded on information recording media having a large volume, real time files on which video and audio data have to be reproduced continuously. Therefore, the number of files which are to be opened increases proportional to the reproduction time period. For example, when contents which take a few hours for reproduction are reproduced, a number of files which take a few seconds for reproduction have to be opened at a time. As a result, reproduction apparatuses require memories having a large capacity.

It is also required to prevent the reliability of data recorded on information recording media from being deteriorated with logical layers of information recording media. For example, since the number of defect sectors increases as the capacity of information recording media increases, it is also required to take sufficient measures with respect to scratches of the sectors which cause defect sectors and the like.

Japanese Laid-Open Publication No. 4-157672 discloses technique for recording/reproducing files with a plurality of operating systems by recording a plurality of file systems different from each other on one information recording medium. However, recording/reproduction of files cannot be provided such that, for example, recording/reproduction of files is allowed in accordance with one file system but recording on files is restricted in accordance with another file system. Only one access method is provided for each of the data areas on which files are recorded.

The present invention is provided in view of the above-described problems. An object of the present invention is to provide a method for accessing information recording media with a first access method provided by first file management information and a second access method provided by a second file management information, and information recording media on which the first file management information and the second file management information are recorded.

### DISCLOSURE OF THE INVENTION

The access method of the present invention is a method for accessing an information recording medium in which a data area is allocated, wherein: first file management information which provides a first access method and second file management information which provides a second access method are recorded in the information recording medium; and the first file management information and the second file management information manage files recorded in the information recording medium, the method comprising the steps of: (a) reading out one of the first file management information and the second file management information; and (b) accessing the data area with the access method provided by one of the read out first file management information and the read out second file management information, thereby achieving the above-described object.

The first access method may be a method for accessing the data area such that the data area functions as a read-only area which allows only reproduction of a file recorded in the data area; and the second access method may be a method for accessing the data area such that the data area functions as an area which allows reproduction of the file recorded in the data area, and also recording of a file in the data area.

The file recorded in the data area may include a core set file and an extension set file; the core set file may be a file for implementing a basic function of a predetermined application; the extension set file may be a file for implementing an extended function of the predetermined application; the first access method may be a method for accessing the data area so as to reproduce the core set file and the extension set file included in the files recorded in the data area; the second access method may be a method for accessing the data area so as to reproduce only the core set file among the core set file and the extension set file included in the files recorded in the data area.

At least one partition which is defined as an area accessible with the first access method and at least one segment which is defined as an area accessible with the second access method may be allocated in the information recording medium; and the data area may be an overlap area in which parts of the at least one partition and the at least one segment overlap each other.

The segment may include a first segment and a second segment; and an area formed of the first segment and the second segment and the partition may overlap each other.

The partition and the segments may be allocated in ECC block units.

The step (b) may include the step of recording a file in the data area, the method may further comprise the step of: (c) updating the first file management information and the second file management information so as to correspond to a record position of the file.

At least one partition which is defined as an area accessible with the first access method and at least one segment which is defined as an area accessible with the second access method may be allocated in the information recording medium; and the data area may be an overlap area in which parts of the at least one partition and the at least one segment overlap each other.

The segment may include a first segment and a second segment; the first segment may be an area in which a non-real time file for implementing a function of a predetermined application is to be recorded; the second segment may be an area in which a real time file for implementing a function of the predetermined application is to be recorded; and the step (b) may include the steps of: determining whether the file to be recorded is the non-real time file or the real time file; when the file to be recorded is the non-real time file, recording the non-real time file in the first segment; and when the file to be recorded is the real time file, recording the real time file in the second segment.

The second file management information may include record end position information which indicates a position where recording is finished; and the step (b) may include the step of recording the file in the data area in accordance with the record end position information.

The record end position information may indicate a position where one way repetitive recording is finished; and the step (b) may include the step of repetitively recording the file in one way in the data area in accordance with the record end position information.

The second file management information may include record position information which indicates a record position of the first file management information; and the step (c) may include the step of updating the record position information of the second file management information so as to correspond to the record position of the updated first file management information.

The first file management information may include first integrity information which indicates whether a state of the first file management information is an open state or a closed state; and the first integrity information indicating the open state may indicate that a file can be recorded in the information recording medium, and the first integrity information indicating the closed state may indicate that a file is normally recorded, the method may further comprise the steps of: putting the first integrity information into the open state before the step (b); and putting the first integrity information into the closed state after the step (b).

The second file management information may include second integrity information which indicates whether a state of the second file management information is an open state or a closed state; and the second integrity information indicating the open state may indicate that a file can be recorded in the information recording medium, and the second integrity information indicating the closed state may indicate that a file is normally recorded, the method may further comprise the steps of: putting the second integrity information into the open state before the step (b); and putting the second integrity information into the closed state after the step (b).

The first file management information may include first file name information for indicating a name of the file recorded in the data area and first record position information for indicating a record position of the file recorded in the data area; and the second file management information may include second file name information for indicating a name of the file recorded in the data area and second record position information for indicating a record position of the file recorded in the data area, the method may further comprise the steps of: determining whether the first file name information and the second file name information correspond to each other; and determining whether the first record position information and the second record position information correspond to each other.

A file may be recorded in the data area, and the step (b) may include the step of reproducing the file.

An access apparatus of the present invention is an apparatus for accessing an information recording medium in which a data area is allocated, wherein: first file management information which provides a first access method and second file management information which provides a second access method are recorded in the information recording medium; and the first file management information and the second file management information manage files recorded in the information recording medium, the apparatus comprising: reading means for reading out one of the first file management information and the second file management information; and accessing means for accessing the data area with the access method provided by one of the read out first file management information and the second file management information, thereby achieving the above-described object.

The accessing means may include recording means for recording a file in the data area, the apparatus may further comprises: updating means for updating the first file management information and the second file management information so as to correspond to a record position of the file.

A file may be recorded in the data area, and the accessing means may include reproducing means for reproducing the file.

An information recording medium of the present invention is an information recording medium in which the first file management information and the second file management information are recorded, wherein: the first file management information and the second file management information manage a file recorded in the information recording medium; the first file management information provides the first access method to a data area allocated to the information recording medium; and the second file management information provides the second access method to the data area, thereby achieving the above-described object.

### BRIEF DESCRIPTION OF THE DRAWINGS

FIG. 1 is a figure showing an information recording medium 100 according to an embodiment of the present invention.

FIG. 2 is a figure showing a directory structure.

FIG. 3 is a figure showing a UDF volume structure and a UDF file structure, and an SVFS volume structure and an SVFS file structure corresponding to the directory structure shown in FIG. 2.

FIG. 4 is a figure showing details of the UDF volume structure.

FIG. 5 is a figure showing a data structure of a UDF file entry.

FIG. 6 is a figure showing a data structure of a UDF allocation descriptor.

FIG. 7 is a figure showing a data structure of a UDF file identifier descriptor.

FIG. 8 is a figure showing details of a first SVFS file structure area 108.

FIG. 9 is a figure showing an example in which a first ring area and a slide area are sequentially allocated to a disc.

FIG. 10 is a figure showing a data structure of an SVFS S volume descriptor recorded in a first ring area 70 shown in FIG. 8.

FIG. 11 is a figure indicating an SVFS file structure recorded in a second ring area shown in FIG. 7.

FIG. 12 is a figure showing a data structure of a recording descriptor.

FIG. 13 is a figure showing a data structure of an S file entry.

FIG. 14 is a figure showing a data structure of an S2 allocation descriptor.

FIG. 15 is a figure showing a data structure of an S3 allocation descriptor.

FIG. 16 is a figure showing another example of the first SVFS file structure area 108.

FIG. 17 is a figure showing positioning of a first ring area 171, a slide area 172, and a third ring area 178.

FIG. 18 is a figure showing a data structure of an S integrity descriptor to be recorded in the second ring area.

FIG. 19 is a figure showing a data structure of an S file descriptor, which is a file structure to be recorded in a third ring area.

FIG. 20 is a figure showing an interpretation of a bit to be recorded in a field for indicating lengths of the S2 allocation descriptor and the S3 allocation descriptor.

FIG. 21 is a figure showing a structure of an information recording/reproduction apparatus 1600 according to one embodiment of the present invention.

FIG. 22 is a flow chart showing a procedure of a formatting process.

FIG. 23 is a figure showing a data structure of the information recording medium after the formatting process.

FIG. 24 is a flow chart showing a file recording process procedure.

FIG. 25 is a flow chart showing a procedure of a file reproducing process.

FIG. 26 is a flow chart showing a procedure of a recording/deleting process using history bits according to the present invention.

FIG. 27 is a figure showing an exemplary area in which a file is recorded/deleted by using the file recording/deleting process procedure using the history bits according to the present invention.

FIG. 28 is a figure showing a data structure of the information recording medium after the formatting process.

FIG. 29 is a figure showing a data structure of the information recording medium after the file is recorded in the information recording medium after the formatting process shown in FIG. 28.

FIG. 30 is a flow chart showing procedures of a compatibility checking process between the UDF volume structure and the SVFS volume structure, and a compatibility checking process between the UDF file structure and the SVFS file structure.

FIG. 31 is a figure showing a data structure of the information recording medium in which files including a core set file and an extension set file is recorded.

FIG. 32 is a figure for showing a directory structure.

FIG. 33 is a flow chart for showing a procedure for producing the information recording medium in which the files including the core set file and the extension set file is recorded.

### BEST MODE FOR CARRYING OUT THE INVENTION

Hereinafter, embodiments according to the present invention will be described with reference to the drawings.

According to the present invention, a file system having a Specific Volume and File structure (hereinafter, referred to as SVFS) is introduced as a new file system. SVFS file systems are used in equipments with low-performance memories and/or CPUs (for example, consumer equipments).

### Embodiment 1

As Embodiment 1 according to the present invention, an information recording medium in which file management information which conforms to UDF and file management information which conforms to SVSF are recorded thereon, a method for accessing the information recording medium, a method for recording files on the information recording medium, a method for reproducing files from the information recording medium, and a reproduction apparatus for realizing access to the information recording media will be described.

1. Data Structure of an Information Recording Medium

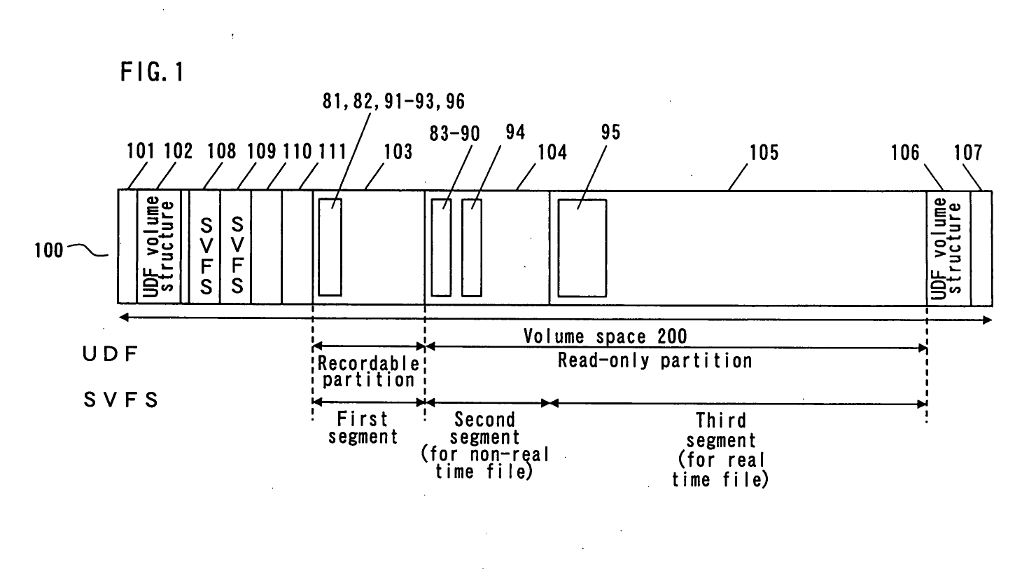

FIG. 1 shows an information recording medium 100 according to an embodiment of the present invention.

A volume space 200 is allocated to the information recording medium 100.

To the volume space 200, an area 101 reserved for systems, a first UDF volume structure area 102, a first data area 103, a second data area 104, a third data area 105, a second UDF volume structure area 106, and an area 107 reserved for systems are allocated. The side on which the area 101 is allocated to the volume space 200 is an inner peripheral side of the information recording medium 100, and the side on which the area 107 exists is an outer peripheral side of the information recording medium 100.

UDF volume structures are recorded on the first UDF volume structure area 102 and the second UDF volume structure area 106. The UDF volume structures are recorded on the first UDF volume structure area 102 on the inner peripheral side of the information recording medium 100 and the second UDF volume structure area 106 on the outer peripheral side of the information recording medium 100 in order to improve the reliability of data.

Information respectively included in UDF volume structures and UDF file structures provides the first access method to the information recording medium 100. The details of the UDF volume structures and the UDF file structures will be described below.

To the volume space 200, a first SVFS file structure area 108, a second SVSF file structure area 109, a first SVFS file structure reserve area 110, and a second SVFS file structure reserve area 111 are further allocated. The SVFS volume structures and file structures are recorded in the first SVFS file structure area 108 and the second SVFS file structure area 109. The first SVFS file structure reserve area 110 and the second SVFS file structure reserve area 111 are reserve areas for recording SVFS volume structures and file structures.

Information respectively included in the SVFS volume structures and the SVFS file structure provides the second access method to the information recording medium 100. The details of the SVFS volume structures and the SVFS file structures will be described below. Further, the details of the first SVFS file structure area 108 will be described below.

The first area 103 is allocated to the information recording medium 100 as a recordable partition and the second area 104 and the third area 105 are allocated as a partition for read-only. Further, the area 103 is allocated to the information recording medium 100 as a first segment, the second area 104 is allocated as a second segment, and the third area 105 is allocated as a third segment.

Herein, a partition is defined as an area which is accessible with the first access method, and a, segment is defined as an area which is accessible with the second access method.

The first access method is provided by information respectively included in the UDF volume structures and the UDF file structures. The second access method is provided by information respectively included in the SVFS volume structures and the SVFS file structures.

The information respectively included in the UDF volume structures and the UDF file structures manages files recorded on the information recording medium 100, and is defined as first file management information. The information included in SVFS volume structures and SVFS file structures manages files recorded on the information recording medium 100, and is defined as second file management information.

When the first area 103 is made to be an area which cannot be accessed in accordance with the second file management information, and which can be recorded in accordance with the first file management information, a recording/reproduction apparatus can record, update, or delete user files on or from the first area 103 in accordance with only the first file management information.

In the second segment, non-real time files are recorded. Non-real time files are files for implementing predetermined functions of applications. The non-real time files are, for example, playlist files for implementing recording/reproduction of video data.

In the third segment, real time files are recorded. The real time files are files for implementing predetermined functions of applications. The real time files are real time data used with the playlist files for implementing recording/reproduction of video data.

When the first access method is a method for accessing the second area 104 and the third area 105 such that the second area 104 and the third area 105 function as a read-only area for only reproducing files recorded in the second area 104 and the third area 105, and the second access method is a method for accessing the second area 104 and the third area 105 such that the second area 104 and the third area 105 function as an area in which files recorded in the second area 104 and the third area 105 can be reproduced and the files can be recorded in the second area 104 and the third area 105, alternation and/or deletion of files recorded in the second area 104 and the third area 105 in accordance with the first file management information can be restricted.

By restricting the alternation and/or deletion of files recorded in the second area 104 and the third area 105 in accordance with the first file management information, compatibility between the UDF volume structures and the SVFS volume structures, and compatibility between the UDF file structures and the SVFS file structures can be maintained.

Specifically, in general, UDF file systems are introduced into personal computers and provide a recording/reproducing function for files to users of personal computers. However, since the UDF file systems handle files universally, there are problems in recording files which require special positioning in order to be used with a specific application, such that suitable positioning cannot be achieved, and the like. For example, when video file is recorded in accordance with UDF file systems, continuous reproduction may be interrupted. Thus, the second area 104 and the third area 105 are managed as a read-only area in accordance with the volume UDF file structures. This allows restricting recording and/or alternation of files which require special positioning in accordance with the UDF file systems. Therefore, it is possible to prevent a user of a personal computer from inadvertently altering files which require special positioning. Since files may be recorded in the first area 103 in accordance with the UDF file systems, it is possible to record marker information and/or simple edit information for video scenes of the video files recorded in the read-only partition to a marker recordable partition.

Furthermore, it is not necessary to mange files recorded in the first area 103 in accordance with the second file management information. This is because the first area 103 is defined as an area which cannot be recorded, updated, or deleted in accordance with the second file management information. Therefore, the number of files managed in accordance with the second file management information is reduced.

By recording non-real time files in the second area 103 defined as the second segment, and recording real time files in the third area 104 defined as the third segment, performance of continuous reproduction of real time files is improved.

Non-real time files have smaller size compared to that of real time files. However, sometimes, the number of non real time files recorded in the information recording medium 100 is greater than that of the real time files. Furthermore, if time for accessing playlist files becomes longer, it is necessary to access a large number of files at a high rate because it takes a longer time to start reproduction of video data. Thus, time for accessing a large number of files can be shortened by allocating a predetermined area to the information recording medium 100 as a record area for non-real time files.

Further, the real time files have large sizes and have to be reproduced continuously. By setting an area for recording real time files, segmentalization of space area is alleviated. Thus, the real time file can be recorded/reproduced efficiently.

When Constant Linear Verocity recording (CLV recording) is performed on the information recording medium 100, there is a difference in the rotation rate of a spindle motor between that at the inner peripheral side of the information recording medium 100, and that at the outer peripheral side. The time for access increases proportionally to the difference in the rotation rate of the spindle motor. If the power of the spindle motor is strong, the percentage of driving time for moving a pickup in the time for access becomes larger. Thus, an amount of data which can be recorded per one circle on the information recording medium is large. When real time data is recorded in a predetermined range at the outer peripheral sides with a lower rotation rate of the spindle motor, worst seek time within the predetermined range can be shortened. As a result, when real time data is divided into a plurality of real time data and recorded in the predetermined range, the real time data divided to a plurality of real-time data can be reproduced continuously.

Further, it is also possible that only one read-only partition is defined in the volume space. In this case, new files cannot be recorded using UDF file systems. Thus, compatibility between the UDF file structures and the SVFS file structures can be maintained. Also, in this case, the first segment and the second segment are defined in the volume space. Non-real time files are recorded in the first segment, and the real time files are recorded in the second segment. As a result, it becomes possible to maintain the compatibility between the UDF file structures and the SVFS file structures even when a recordable partition is not set in the volume space. Further, a suitable positioning of non-real time files and real time files becomes possible.

The SVFS file structure areas may be located in the second segment or the third segment. This is because the SVFS file structure areas are data structures having a table format and the areas may be reserved in advance.

Further, the second segment may be set in the third segment. This is because real time files are not recorded in the area allocated as the second segment.

When the area formed of the second segment and the third segment and the read-only partition overlap, compatibility check for the UDF file structures and the SVFS file structures can be readily performed.

Further, by allocating the first area 103, the second area 104 and the third area 105 to the volume space 190 in ECC block units, a control system can readily indicate recording/reproduction of data in ECC block units. This is because data is recorded in ECC block units formed of a plurality of sectors in information recording/reproduction apparatuses.

Recording SVFS file structures allows recording, updating and deleting files recorded in segments and also restoring UDF file structures which cannot be read out, even when the UDF file structures cannot be read out due to defect sectors, or the like.

When SVFS file structures are to be recorded in the first SVFS file structure reserve areas 110 or the second SVFS file structure reserve area 111, the reliability of the file structures can be further improved.

When the recording/reproduction apparatuses cannot read the SVFS file structures recorded in the first SVFS file structure area 108, the system reads out the SVFS file structure from the second SVFS file structure area 109, and writes into the first SVFS file structure reserve area 110. Further, in order to show that the first SVFS file structure are 108 is invalid, the system writes 00 data into the first SVFS file structure are 108. Thus, when the recording/reproduction apparatus reads out the SVFS file structures, the system first reads out 00 data written into the first SVFS file structure area 108, and then reads out the SVFS file structures written into the second SVFS file structure area 109.

When the recording/reproduction apparatus cannot read out the SVFS file structure recorded in the second SVFS file structure area 109, the recording/reproduction apparatus reads out the SVFS file structures from the first SVFS file structure reserve area 110, and writes into the second SVFS file structure reserve area 111. Further, in order to show that the second SVFS file structure area 109 is invalid, the recording/reproduction apparatus writes 00 data into the second SVFS file structure area 109. Therefore, when the recording/reproduction apparatus reads out the SVFS file structures, the recording/reproduction apparatus first reads out 00 data written into the first SVFS file structure area 108, then, reads out 00 data written into the second SVFS file structure area 109, and reads out the SVFS file structures written into the first SVFS file structure reserve area 110.

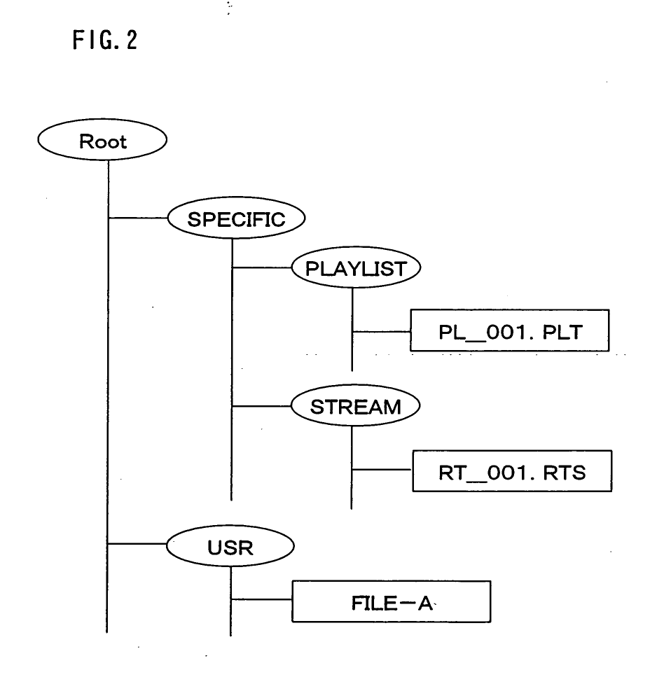

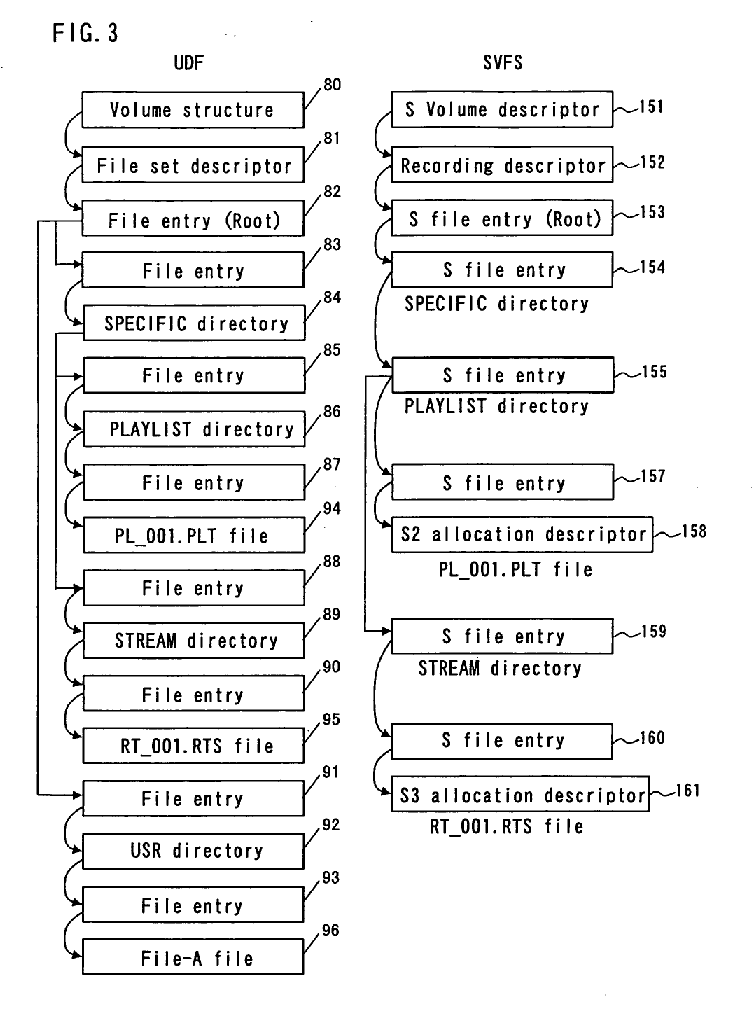

FIG. 2 shows a directory structure. The information recording medium 100 includes files managed by a directory structure as shown in FIG. 3 recorded therein.

The directory structure includes SPECIFIC directory and USR directory. SPECIFIC directory is a directory for recording files used by predetermined applications. USR directory is a directory for recording data files of users.

The directory structure further includes PLAYLIST directory and STREAM directory. SPECIFIC directory includes PLAYLIST directory and STREAM directory recorded therein. PLAYLIST directory includes data files for controlling such as designating an interval for reproduction of video and audio data, for example, playlist file PL_{—}001.PLT, recorded therein. STREAM directory includes real time files with video data and audio data recorded therein which are to be used by the playlist, for example, real time file RT_{—}001.RTS, recorded therein.

To USR directory, generated document files may be recorded, or backup files of users may be recorded. For example, file FILE-A is recorded in USR directory.

FIG. 3 shows the UDF volume structure and the UDF file structure, and the SVFS volume structure and the SVFS file structure corresponding to the directory structure shown in FIG. 2.

FIG. 3 shows a volume structure 80 as the UDF volume structure. The volume structure 80 includes information for logically handling information recording medium as a volume.

The UDF file structure includes a file set descriptor 81, a file entry 82, a file entry 91, a USR directory 92, a file entry 93, and a FILE-A file 96. The file set descriptor 81 includes information for managing a plurality of files as a file set. The file entry 82 includes information indicating a root directory. As shown in FIG. 1, the file set descriptor 81, the file entry 82, the file entry 91, the USR directory 92, the file entry 93, and the FILE-A file 96 are recorded in the first area 103.

The UDF file structure further includes a file entry 83, a SPECIFIC directory 84, a file entry 85, a PLAYLIST directory 86, a file entry 87, a file entry 88, a STREAM directory 89, a file entry 90, and a PL_{—}001.PLT file 94. The PL_{—}001.PLT file 94 is a playlist file. As shown in FIG. 1, these files 83 through 90 and the PL_{—}001.PLT file 94 are recorded in the second area 104. As shown in FIG. 1, in the third area 105, an RT_{—}001.RTS 95 is recorded. The RT_{—}001.RTS file 95 is a real time file.

Here, the directory is recorded and managed by the file entry as a file.

The details of these data structures included in the UDF volume structure and the UDF file structure will be described later.

FIG. 3 shows an S volume descriptor 151 as the SVFS volume structure. The S volume descriptor 151 includes information for logically handling the information recording medium as a volume.

The SVFS file structure includes a recording descriptor 152, an S file entry 153, an S file entry 154, an S file entry 155, an S file entry 157, an S2 allocation descriptor 158, an S file entry 159, an S file entry 160, and an S3 allocation descriptor 161. The details of these files included in the SVFS file structure will be described later.

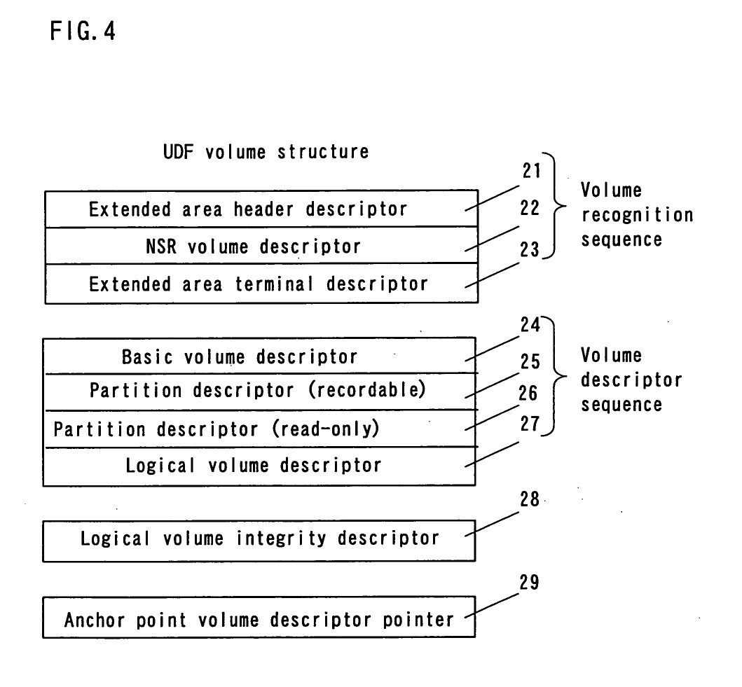

FIG. 4 shows details of the UDF volume structure.

The UDF volume structure includes an extended area header descriptor 21, an NSR volume descriptor 22 which indicates being formatted with ECMA167, and an extended area terminal descriptor 23. The extended area header descriptor 21, the NSR volume descriptor 22, and the extended area terminating descriptor 23 are included in a volume recognition sequence.

The UDF volume structure further includes a basic volume descriptor 24, a partition descriptor 25 which indicates an allocation position for the recordable partition, a partition descriptor 26 which indicates an allocation position for the read-only partition, and a logical volume descriptor 27 for integrating the recordable partition and the read-only partition as a logical volume space. The basic volume descriptor 24, the partition descriptor 25, the partition descriptor 26, and the logical volume descriptor 27 are included in a volume descriptor sequence.

The UDF volume structure further includes a logical volume integrity descriptor 28 which indicates a state of disc integrity, and an anchor point volume descriptor pointer 29 which indicates the position of the volume descriptor sequence.

The anchor point volume descriptor pointer 29 is defined to be recorded in at least two of a sector indicated by sector number 256, a sector indicated by the last sector number, and a sector indicated by the last sector number subtracted by 256. Thus, the recording/reproduction apparatus which read out the UDF file structure, access from the sectors indicated by these numbers.

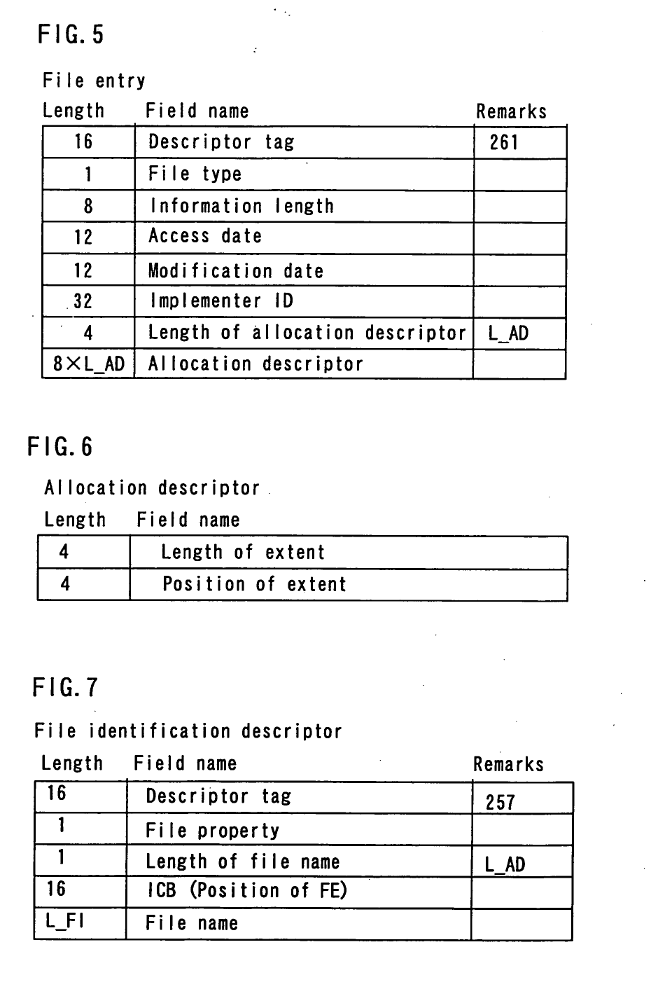

FIG. 5 shows a UDF data structure file entry.

The file entry includes a field for indicating a descriptor tag, a field for indicating a file type which shows what kind of file it is, a field for indicating an information length which shows the number of bytes, a field for indicating an access date which shows when the file is generated, a field for indicating a modification date which shows when the file is altered, a field for indicating an implementer ID for identification of a manufacturer which implements the file system which generated the file entry, a field for indicating a length of the allocation descriptor, and a field for indicating the data allocation descriptor which shows a record position of the data. When the field for indicating the descriptor tag is an ID of the file entry, 261, the system recognizes that the data structure is the UDF file entry.

FIG. 6 shows a data structure of the UDF allocation descriptor.

The allocation descriptor includes a field for indicating a length of extent, and a field for indicating a position of the extent. The position of the extent is indicated by a starting position of the extent. An extent is a continuous area in which designated data is recorded.

When data is separated and recorded in two extents, a field indicating two allocation descriptors is included in the file entry. The size of the file entry is one sector or less, and the file entry is recorded from the header of the sector.

When the size of the file or the directory is small, data of the file may be included in the last field included in the file entry. For example, when the sector is 2 KByte (KB), the data of the file is 1 KB, parameters recorded in the file entry is usually 176B. Thus, the data of the file is recorded in the last field of the file entry.

FIG. 7 shows a data structure of a UDF file identifier descriptor.

The file identifier descriptor includes a field for indicating a descriptor tag, a field for indicating a file property which is information on the directory, a field for indicating a length of file name, a field for indicating ICB which is a position of the file entry managing the file, and a field for indicating the file name. When the descriptor tag indicates an ID of the file identifier descriptor, 257, the system recognizes that the data structure is the UDF file identifier descriptor.

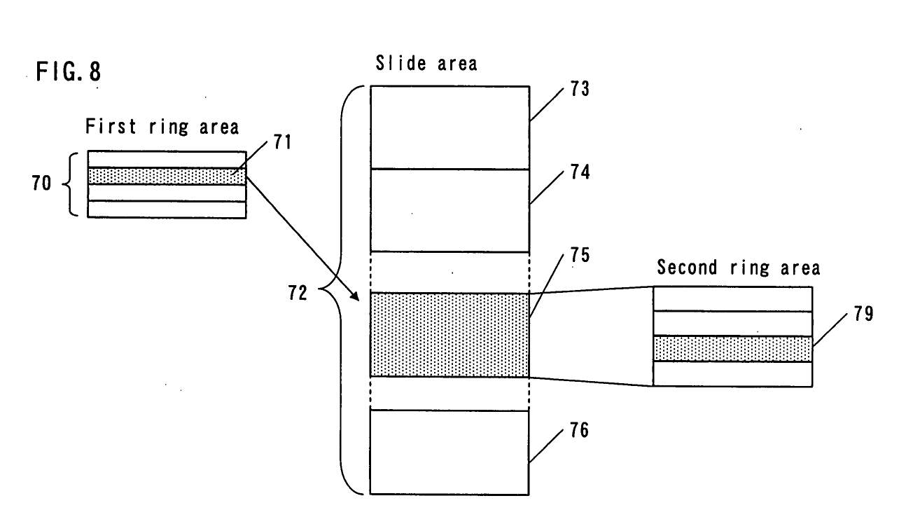

FIG. 8 shows details of the first SVFS file structure area 108. To the first SVFS file structure area 108, a first ring area 70 and a slide area 72 are allocated.

To the first ring area 70, four blocks are allocated. One of the four ECC blocks is an ECC block 71.

To the slide area 72, 32 second ring areas are allocated. Some of the 32 second ring areas are shown as second ring areas 73 through 76. To each of the second ring areas, 8 ECC blocks are allocated with an allocation unit of two ECC blocks. ECC blocks respectively allocated to 32 second ring areas include ECC blocks 79 formed of two valid ECC blocks.

In the valid ECC block 71 allocated to the first ring area 70, the SVFS volume structure is recorded. In the ECC block 79, the SVFS file structure is recorded. By recording the SVFS volume structure to the first ring area, and the SVFS file structure to the second ring area, the number of times to rewrite the file structure can be increased. Therefore, in the information recording media with a smaller number of times of rewriting sectors, even when the number of times to rewrite the file management information as the file is recorded, it is possible to avoid a specific sector becoming a defect sector due to physical fatigue. As a result, the reliability of the information recording media with the smaller number of times of rewriting the sectors can be improved.

The SVFS volume structure recorded in the ECC block includes a sequence number. Every time a recording operation is performed, the sequence number is incremented by 1. Thus, the ECC block which includes the SVFS volume structure including the largest sequence number is a valid ECC block.

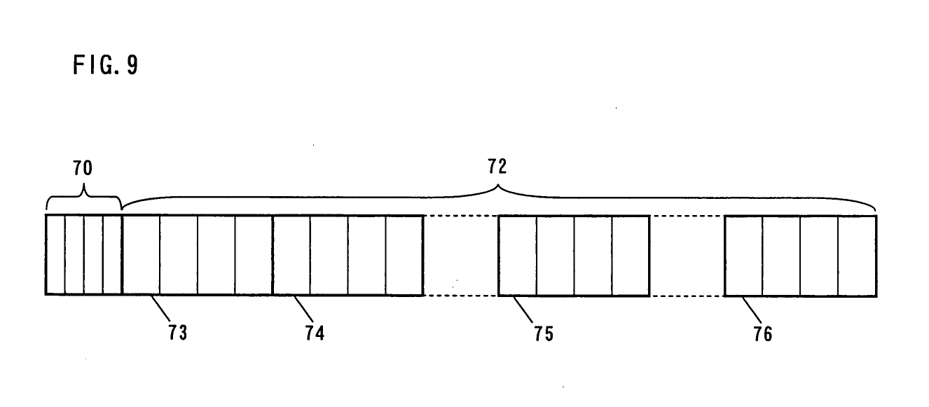

FIG. 9 shows an example where the first ring area and the slide area are allocated in series.

When the first ring area 70 and the slide area 72 are allocated in series, information of the file structure can be read out faster compared to the example in which they are not allocated in series. This is because, when a ring recording method which will be described later is used for an information recording medium for which the number of times for rewriting is 50, information of the file structure recorded in 12 ECC blocks since the first ring area 70 and the second ring area with the valid ECC block allocated thereto are allocated in series if the rewriting of the SVFS file structure is below 200 times.

The ECC blocks are updated and recorded in a certain direction such that the recording direction in the second ring area has a ring shape. When it reaches a terminal of the second ring area, recording of files is performed by recording from a header of the second ring area.

When the second ring area cannot be used anymore due to rewriting fatigue, files are recorded in the next second ring area in the slide area. In order to indicate that the position of the second ring area is changed, the SVFS volume structure recorded in the first ring area is updated.

The ECC blocks are updated and recorded in a certain direction such that the recording direction in the first ring area has a ring shape. When it reaches a terminal of the first ring area, recording of files is performed by recording from a header of the first ring area. As described above, by performing recording of a ring shape in a hierarchical manner, even when the number of times of recording data onto the second ring area, updating and recording can be performed.

For example, in an optical disc for which the number of times for rewriting is 50, file recording can be performed 50×4 times in view of the number of times of updating the second ring area. Further, since 32 second ring areas are allocated in the slide area, File structures can be recorded 50×4×32.

In order to look for valid ECC blocks in the second ring area, four ECC blocks are read from the first ring area, and a valid ECC block among them is detected to obtain the position of the second ring area. Eight ECC blocks are read out from the second ring area, and two valid ECC blocks are found from them. Thus, time for reading out data is shorter compared to the example which reads out all the slide area.

For example, in an embodiment shown in FIGS. 8 and 9, ring recording corresponds to “one way repetitive recording for repetitively recording files in data areas in one way in accordance with recording terminating position information”.

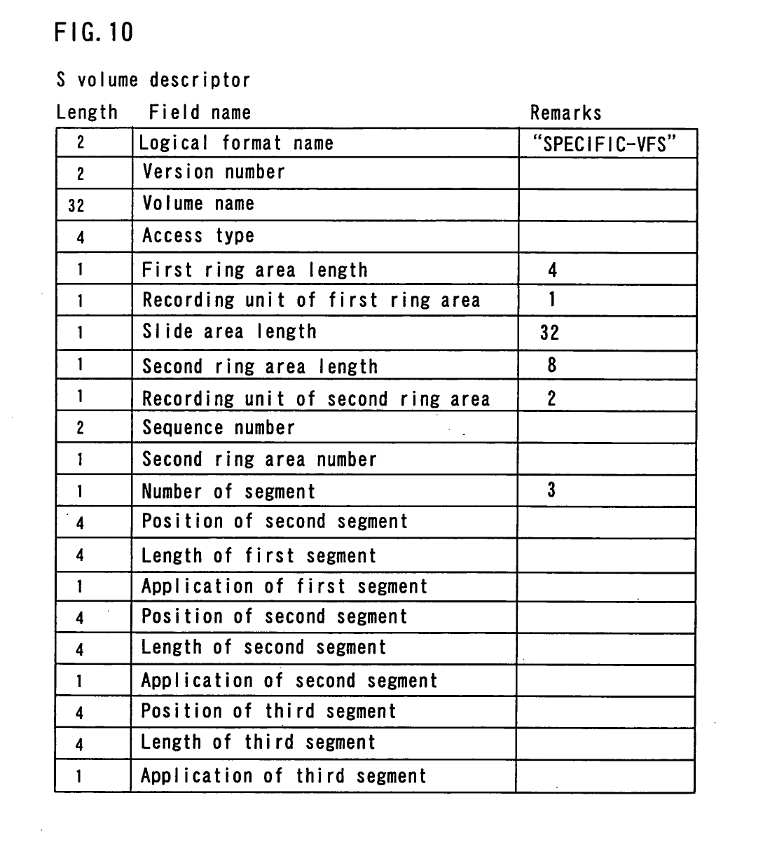

FIG. 10 shows a data structure of the SVFS S volume descriptor which is recorded in the first ring area 70 shown in FIG. 8. The S volume descriptor describes the SVFS volume structure.

The S volume descriptor includes position information of segment which is not rewritten as frequently as position information of the file and/or position information of the ring area and the slide area. By recording information which is less frequently updated and information more frequently updated separately in the first ring area and the second ring area, ring recording is efficiently performed.

The S volume descriptor is also used for recording information which is not defined with the UDF volume structure among information recorded in the information recording media at a logical formatting.

The S volume descriptor includes a field for indicating a logical format name and a field for indicating aversion number in order to show that the SVFS volume structure is Version 1.0. The S volume descriptor further includes a field for indicating a volume name of an optical disc in which the S volume descriptor is recorded, a field for indicating an access type, a field for indicating the first ring area, a field for indicating a recording unit of ECC blocks recorded in the first ring area, a field for indicating a length of a slide area, a field for indicating a length of the second ring area, and a field for indicating a recording unit of ECC blocks recorded in the second ring area. The fields, respectively indicating the length of the first ring area, the recording unit of ECC blocks recorded in the first ring area, the length of the slide area, the length of the second ring area, and the recording unit of ECC blocks recorded in the second ring area, are indicated by the number of ECC blocks.

The S volume descriptor further includes a field for indicating the sequence number, a field for indicating the second ring area number which shows a valid second ring area, a field for indicating the number of segments divided in accordance with an application, a field for indicating the positions of the segments, a field for indicating the length of the segments, and a field for indicating the applications of the segments. The sequence number is incremented by one every time the S volume descriptor is updated. The ECC block in which the S volume descriptor including the largest sequence number is recorded is a valid ECC block. Applications of the segments may include, for example, three types (\textcircled{1} recording of file managed in accordance with the first file management information, and not managed in accordance with the second file management information, \textcircled{2} recording of non-real time data managed in accordance with the first file management information and the second file management information, and \textcircled{3} recording of real time data managed in accordance with the first file management information and the second file management information).

FIG. 11 shows the SVFS file structure which is recorded in the second ring area shown in FIG. 7. The SVFS file structure includes a recording descriptor, a table of the S file entry, a table of the S2 allocation descriptor which indicates the record position of the file recorded in the second segment, and a table of the S3 allocation descriptor which indicates the record position of the file recorded in the third segment.

The reason why the S2 allocation descriptor and the S3 allocation descriptor are expressed in a table format independently from the S file entry will be described below.

One S file entry is necessary for each of the files. However, when double-recording of the file is performed, two S2 allocation descriptors are necessary for one S file entry. When the real time file is divided and recorded in a plurality of extents, a plurality of S3 allocation descriptors are necessary for one S file entry.

Further, by allocating the allocation descriptors in a table format for each of the segments, management of blank areas in the segments becomes easier. For example, each of the continuous areas in which the real time files are recorded require a predetermined size for continuously reproducing the real time files. However, the number of the allocation descriptors which manage the real time files does not increase too much. Thus, a bit map for managing blank areas is not necessary. Further, files other than the playlist file such as thumbnail and the like is in the PLAYLIST directory, and number of files recorded in the second segment becomes larger, it is only necessary to record a space bit map for managing the blank area in the second segment. Therefore, the size of the bit map can be reduced since the size of the second segment is smaller than that of the third segment.

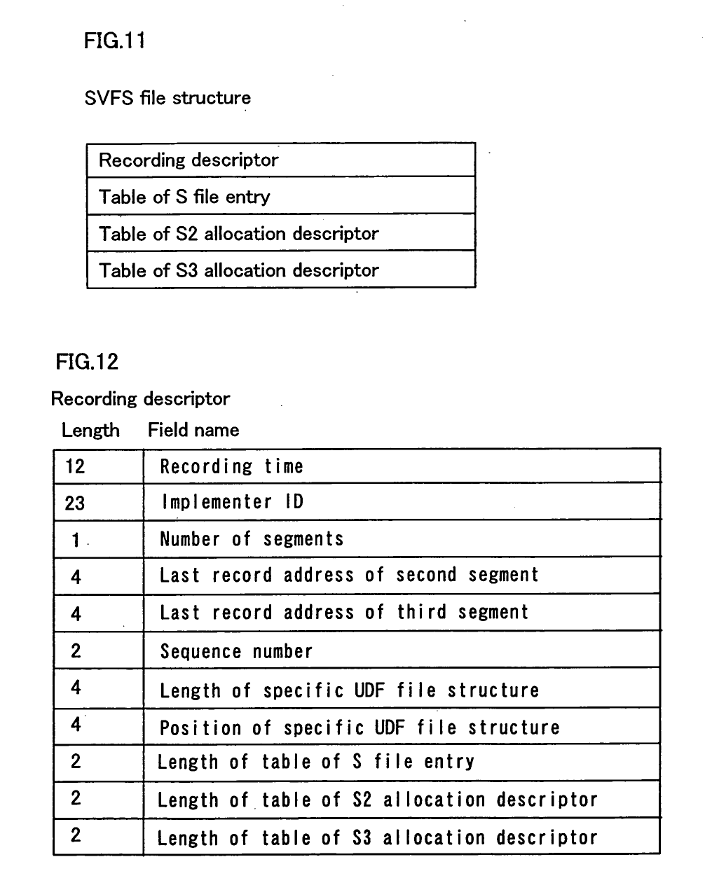

FIG. 12 shows a data structure of recording descriptor.

The recording descriptor includes a field for indicating a recording time, a field for indicating the implementer ID, a field for indicating the number of segments, a field for indicating the last record address of the second segment, a field for indicating the last record address of the third segment, a field for indicating the sequence number, a field for indicating a length of a specific UDF file structure, a field for indicating the position of the specific UDF file structure, a field for indicating a length of the table of the S file entry, a field for indicating a length of the table of the S2 allocation descriptor, and a field for indicating the table of the S3 allocation descriptor.

The sequence number is incremented by 1 every time the S file structure is updated. The ECC block with the S file structure including the largest sequence number recorded therein is a valid ECC block.

The field for indicating the recording time indicates the time when the data of the recording descriptor is generated. A field of a recording time of the logical volume integrity descriptor included in the UDF volume structure also indicates the time when the data of the logical volume integrity descriptor is generated. The compatibility between UDF volume structure and the SVFS volume structure, and the compatibility of the UDF file structure and the SVFS file structure are determined based on these pieces of time information. If these time information pieces are equal, it can be determined that there are the compatibility between the UDF volume structure and the SVFS volume structure, and the UDF file structure and the SVFS file structure.

The field for indicating the implementer ID indicates the ID of the manufacturer which has developed the file system which updates and records the file structure. By including the field for indicating the implementer ID in the file structure, problems regarding compatibility can be readily solved even when they occur. Further, since the file structure is not overwritten but updated and recorded using the ring record, the past record remains. Thus, the history is used to help the compatibility problems to be solved.

The field for indicating the number of segments indicates the number of segments divided in accordance with applications.

The field for indicating the last record address in the second segment indicates the last address of the area where the data is recorded last. When the system records data in the second segment, the system searches for a blank area in a direction toward address larger than the last record address, and then records data. When the search for a blank area reaches the terminal of the second segment, the system searches for a blank area from the header of the second segment, and records data. Thus, it is possible to prevent the system from repetitively recording a specific area.

The field for indicating the last record address in the third segment indicates the last address of the area where the data is recorded last. When the system records data in the third segment, the system searches for a blank area in a direction toward an address larger than the last record address, and then records data. When the search for a blank area reaches the terminal of the third segment, the system searches for a blank area from the header of the third segment, and records data.

When recording data on a write once read many information recording medium, the last record address in the second segment and the last record address in the third segment may be used as information for identifying the position to start the recording next time.

The field for indicating the length and the position of the specific UDF file structure indicates information on the position where the UDF file structure of SPECIFIC directory and the following directories is recorded. A plurality of files managed by SVFS are opened and reproduced at the same time. Thus, by collectively recording the position information of the UDF file structure managing these files, it is possible to shorten the time for opening these files in accordance with the UDF file system. If a real time file is recorded in the third segment in accordance with the SVFS file systems, the UDF file structure which manages the real time file is recorded in the second segment. In the case where the UDF file structure cannot be read out due to damage in the area in which the UDF file structure is recorded, by recording the record position of the UDF file structure in the SVFS file structure, it is no longer necessary to trace the UDF file structure. There is a merit that the UDF file structure can be readily modified. The same effect can be obtained by registering the specific UDF file structure to the SVFS file structure as a specific file.

The start positions of the tables are apparent from the fields respectively showing the length of the table of the S file entry, the length of the table of the S2 allocation descriptor, and the length of the table of the S3 allocation descriptor.

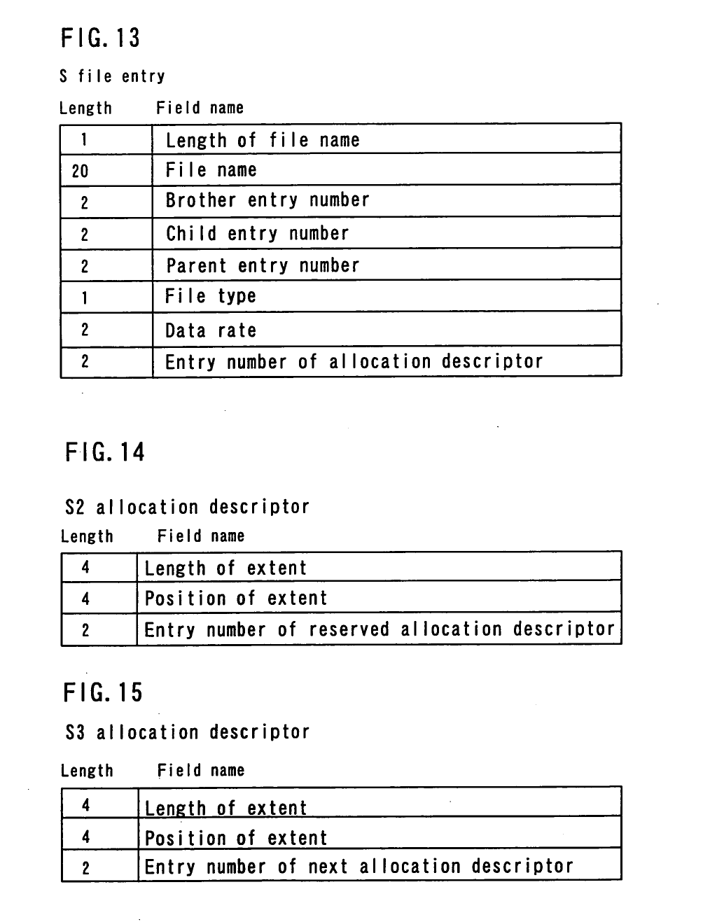

FIG. 13 shows a data structure of the S file entry.

In the table of the S file entry, S file entries are recorded for every file or every directory recorded in the second segment and the third segment.

The S file entry includes a field for indicating a length of the file name, and a field for indicating the file name. The field for indicating the file name indicates the file name of 20 Byte or the directory name. In an application for recording/reproducing real time files, the file names are decided in accordance to previously defined rules. Thus, there is no inconvenience in limiting the length of the file names. Further, by limiting the length of the file names, the size of the S file entries can be made smaller.

The S file entry further includes a field for indicating brother entry numbers, a field for indicating child entry numbers, and a field for indicating parent entry numbers. The brother entry numbers, the child entry numbers, and parent entry number indicate a hierarchical relationship in the directory structure. The entry numbers are given to the S file entries sequentially from the header of the table of the S file entry. The brother entry numbers are numbers of S file entry indicating files or directories which belong to the same directory as the file or directory indicated by the S file entry. The child entry numbers are entry number of S file entry indicating files or directories in a lower tier than the directory indicated by S file entry. The parent entry numbers are entry numbers of the S file entry indicating directories in a higher tier than the file or directory indicated by the S file entry.

The S file entry further includes a field for indicating a file type, a field for indicating the data rate, and a field for indicating the entry number of the allocation descriptor. The field for indicating the file type indicates whether the file is a non-real time file, a real time file, or a directory. If the file is the real time file, the field for indicating the data rate indicates data rate of the real time file. If the file is non-real time file, the field for indicating the entry number of the allocation descriptor indicates the entry number of the S2 allocation descriptor indicating the record position of the file. If the file is a realtime file, it indicates the entry number of S3 allocation descriptor indicating the record position of the file.

FIG. 14 shows a data structure of the S2 allocation descriptor.

The data structure of S2 allocation descriptor is expressed in a table format. In the table of the S2 allocation descriptor, the S2 allocation descriptors are recorded for every file or every directory recorded in the second segment.

The S2 allocation descriptor includes a field for indicating a length of the extent, a field for indicating the position of the extent, and a field for indicating the entry number of a reserved allocation descriptor. The field for indicating the length of the extent and the field for indicating the position of the extent indicate the record position of the extent of the file. If the file is a non-real time file, the field for indicating the length of the extent and the field for indicating the position of the extent are double-recorded in order to secure the reliability of the data. The field for the entry number of the reserved allocation descriptor indicates the entry number of the S2 allocation descriptor indicating the record position of the data to be double-recorded.

FIG. 15 shows a data structure of the S3 allocation descriptor.

In the table of the S3 allocation descriptor, the S3 allocation descriptors are recorded for every file recorded in the third segment.

The S3 allocation descriptor includes a field for indicating the length of the extent, a field for indicating the position of the extent, and a field for indicating the entry number of the reserved allocation descriptor. The field for indicating the length of the extent and the field for indicating the position of the extent indicate the record position of the extent of the file. If the file is a real time file, since the data is divided and recorded in a plurality of extents, the entry number of the S3 allocation descriptor which indicates the next extent is recorded in a field for indicating the entry number of the next allocation descriptor.

In the SVFS file structure, for example, the recording descriptor has a length of 64 Byte, the S file entry has a length of 32 Byte, and the S2 allocation descriptor and the S3 allocation descriptor have a length of 10 Byte. When 1000 real time files and 1000 playlist files are recorded, the size of the table of the S file entry is little less than 64 KB, the table size of the S2 allocation descriptor is little less than 20 KB, since a double-recorded portion is included, and the table size of the S3 allocation descriptor is little less than 44 KB when the total number of extents is 4500. In the information recording medium where 1 ECC block is 64 KB, the SVFS file structure can be recorded with 2 ECC blocks. For limiting the number of files to be recorded, the S2 allocation descriptor and the S3 allocation descriptor may be expressed in common table. As described above, while the UDF file structure is in a sector format, the SVFS file structure is in a table format where information is recorded on a table for every management information, and thus, the data structure is compact.

Further, by limiting the size of data recordable area in accordance with the UDF file structure, a substitute area can be made smaller using a linear placement method, or a defect management method by sparing table defined in UDF Revision 2.0. This is because, when the SVFS file system records data in the second segment, it can record data while avoiding defect areas by verifying, and when the system records data in the third segment, it can record data while avoiding the defect areas previously detected by performing skip recording.

As described above, introducing the SVFS file system can help improving a real-time characteristic and data reliability while securing the reproduction compatibility and recording compatibility with the existing UDF file system. Further, if the total number of files used in a predetermined application is limited to 2000, and the total number of extents of the real time files is limited to 4500, the volume structure of the SVFS can be expressed in the size within 1 ECC, and the SVFS file structure can be expressed in the size within 2 ECC. Thus, even when the duplicate-recording is performed using the ring-recording, the record/reproduction time is not a problem.

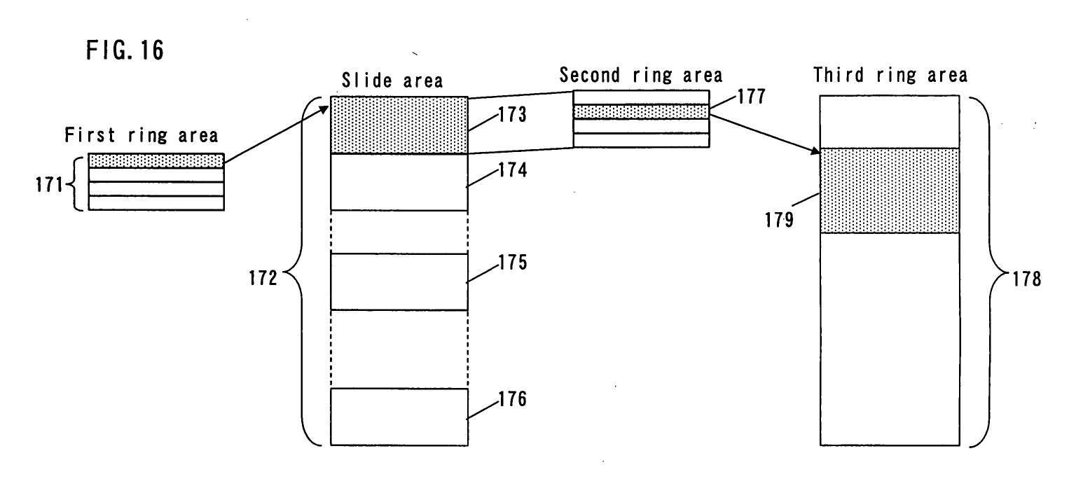

FIG. 16 shows another example of the first SVFS file structure area 108. This example shows the first SVFS file structure area 108 which can handle files even when there are 10,000 files or more. Three areas (a first ring area, a second ring area, and a third ring area) are allocated in the first SVFS file structure area 108. The volume structure is recorded in the first ring area, and the file structure is recorded in the second ring area and the third ring area, separately from each other. Thus, recording/reproduction is performed efficiently. Although the S integrity descriptor is described as a file structure below for the sake of convenience, in the definition of ECMA167, integrity descriptors are defined as volume structures.

In the first SVFS file structure area 108, a first ring area 171, a slide area 172, second ring areas, and a third ring area 178 are allocated. The first ring area 171 is formed of four ECC blocks. The slide area 172 is formed of 64 second ring areas.

Some of the 64 second ring areas are shown as a second ring area 173, a second ring area 174, a second ring area 175, and a second ring area 176 in the figure. For performing management of opening and closing, twice the number of second ring areas in the example shown in FIG. 8 are allocated in the slide area 172. Each of the second ring areas is formed of four ECC blocks with having one ECC block as a recording unit.

The valid ECC block in the first ring area indicates the position of the valid second ring area 173 in the slide area. The data recorded in the valid ECC block 177 in the second ring area indicates the position of the valid area 179 in the third ring area 178.

The data is ring-recorded in the first ring area 171, the second ring area 173, and the third ring area 178. The method in which, when the second ring is fatigued due to rewriting of the second ring area, next second ring area is used to newly record data is the method described with reference to FIG. 8.

When the number of the files increases, the information for managing the files cannot be fit into a few ECC blocks but into dozens of ECC blocks. For example, if information managing the files is 42 B (Byte) per file, about 38 ECC blocks are necessary for managing 60,000 files. In such a case, when information managing the files is recorded in the second ring area, 152 ECC blocks are required as the second ring area. In order to find the information managing the valid file, 152 ECC blocks have to be read out. If three ring record areas are provided, and the area in which the information managing file is recorded is managed by the second ring area, it is only necessary to read out four ECC blocks of the second ring area, access the header of the third ring area, and reads out 38 ECC blocks. Thus, data can be read out more rapidly.

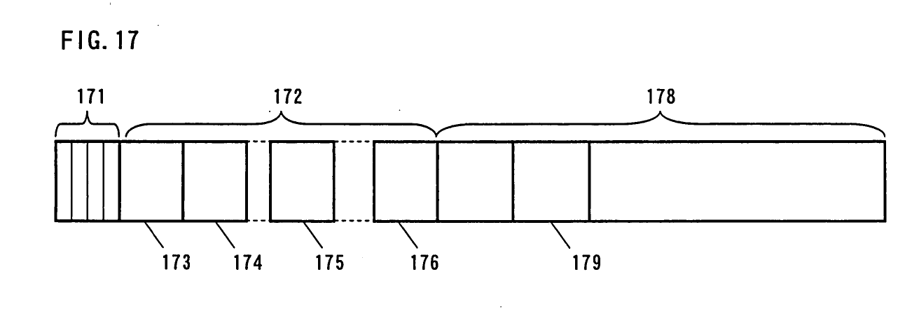

FIG. 17 shows positioning of the first ring area 171, the slide area 172, and the third ring area 178 on the information recording medium.

In the case where the size of the third ring area such that half the number of rewriting of the second ring are equals the number of rewriting the third ring area to record integrity information indicating whether the state of the information managing the file is an open state or a closed state in the second ring area, there is less waste of areas. When the size of the second ring area is 64 ECC blocks, the size of the third ring area is 32×38 ECC blocks.

As described above, if the area in which the file structures are recorded is separated into the second ring area, and the third ring area, and three areas, including the first ring area, are allocated to record data, ring-recording can be efficiently performed even though the number of files increases.

As in the example shown in FIG. 8, the valid ECC block in the first ring area, the second area, the third ring area is the ECC block including the largest sequence number recorded therein.

In the example described above, the third ring area is positioned in the area following the second ring area. However, the effect of the present invention can be achieved even when the third ring area is located in a remote area.

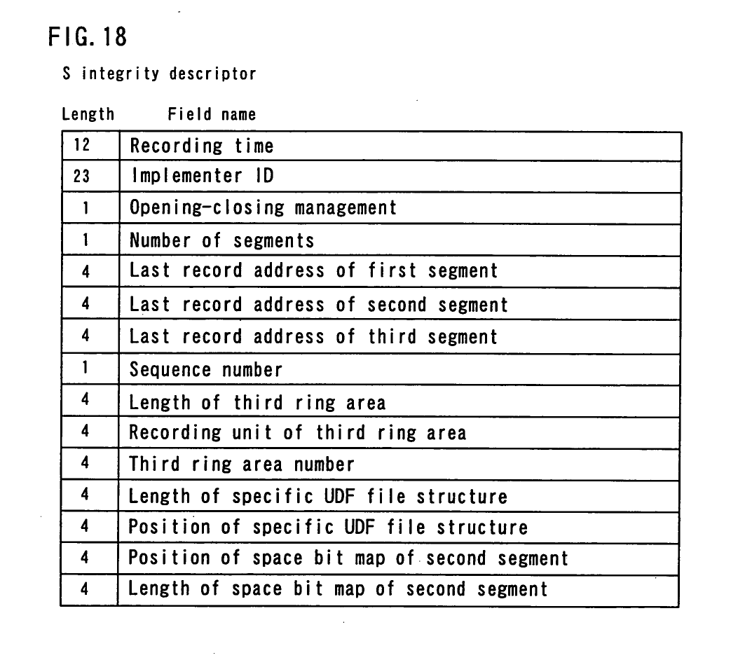

FIG. 18 shows a data structure of the S integrity descriptors recorded in the second ring area. There are two types of SVFS file structures to be recorded in the second ring area: S integrity descriptors, and S file descriptors.

The S integrity descriptors include a field for indicating the recording time, a field for indicating the implementer ID, an opening-closing management field, a field for indicating the number of segments, a field for indicating the last record address of the first segment, a field for indicating the last record address of the second segment, a field for indicating the last record address of the third segment, a field for indicating the sequence number, a field for indicating a length of the third ring area, a field for indicating recording unit of the third ring area, a field for indicating the third ring area number, a field for indicating a length of the specific UDF file structure, a field for indicating the position of a specific UDF file structure, a filed for indicating a position of a space bit map of the second segment, and a field for indicating a length of the space bit map of the second segment.

The sequence number is incremented by one every time the S integrity descriptor is updated. The ECC block in which the S integrity descriptor including the largest sequence number is a valid ECC block.

The field for indicating the recording time indicates the time when the data of the descriptor is generated. The field for indicating the implementer ID indicates an ID of the manufacturer which has developed the file system which updates and records the file structure. The field for indicating the number of segments indicates the number of segments divided in accordance with the applications.

The field for indicating the last record address in the first segment indicates the last address of the area in which the data is recorded last. When data is recorded on a write once read many disc in accordance with the UDF file system, the information recording/reproduction apparatus can obtain the position information which indicates the position to record data by reading out the field for indicating the last record address in the first segment without inquiring for the position information which indicates the position to record data to an optical disc drive or the like.

The field for indicating the last record address in the second segment and the field for indicating the last record address in the third segment also indicate the last address of the area in which the data is recorded last.

When the system records data in the second segment or the third segment, the system searches for a blank area in a direction toward address larger than the last address, and records data. When searching for the blank area reaches the terminal of the second segment or the third segment, the system searches for a blank area from the header of the second segment or the third segment, and record data. Thus, it is possible to prevent the system from repetitively recording a specific area.

The field for indicating the length and the position of the specific UDF file structure indicates information on a position where the UDF file structure of SPECIFIC directory and the following directories.

The opening-closing management field acts as an integrity field of the logical volume integrity descriptor of ECMA167. Specifically, for recording some data in the segments, 1 is recorded before the data is recorded for indicating that the state of the data to be recorded in the field is open. When the information recording medium is ejected, for ensuring that recording of data in the information recording medium is normally finished, the SVFS opening-closing management field and the UDF integrity field are updated, and the state of the recorded data becomes the closed state.

By stopping recording open information in the logical volume integrity descriptor included in the UDF file structure, the number of rewriting the logical volume integrity descriptor can be halved.

Further, usually, the UDF file system rewrites the logical volume integrity descriptor every time the file is updated. The SVFS file system manages opening and closing, and updates the logical volume integrity descriptor when the information recording medium is ejected. According to this, the number of times the logical volume integrity descriptor is rewritten can be further reduced. By recording the integrity information in the SVFS file structure, the integrity state (open state or closed state) of the data recorded in the information recording medium can be seen even when the process is performed in accordance with only the SVFS file structure.

The integrity information included in the UDF file structure may be put into the open state before recording the file, and then the integrity information included in the UDF file structure may be changed into the closed state after recording the file or after recording the file and the management information thereof. The integrity information included in the SVFS file structure may be put into the open state before recording the file, and then the integrity information included in the SVFS file structure may be changed into the closed state after recording the file or after recording the file and the management information thereof.

In general, the UDF integrity information recorded in the read-only partition is not rewritten, but the integrity information included in the UDF file structure before recording the file. If the user determined that it is not necessary to reproduce files in accordance with the UDF file structure, UDF file structure does not have to be updated. Thus, the number of times of the UDF file structure is updated can be decreased. When the user inserts the information recording medium to the system controlled by the UDF file system, the integrity information of the UDF file structure indicates the open state even the UDF file structure is not updated. Thus, when access is performed in accordance with the volume structure or UDF file structure, it is apparent that recording of the data is not normally finished.

The field for indicating the length of the third ring area indicates the position of the third ring area, and information on the position of the file structure recorded in the third ring area. The field for indicating the recording unit of the third ring area indicates a recording unit of information managing files recorded in the third ring area.

The field for indicating the length of the space bit map of the second segment and the field for indicating the position of the space bit map of the second segment indicate a position of the space bit map indicating blank areas of the second segment. As the number of the files to be recorded in the second segment increases, the number of the extents in the second segment increases. Thus, it becomes difficult to search all the S2 allocation descriptors in the S2 allocation descriptor table to check for a blank area. Therefore, the space bit map is used to manage the blank areas. Further, in the case where the number of the extents of the third segment increases and blank areas are dispersed, the bit map is required for managing blank areas. In such a case, the S integrity descriptor may further include a field for indicating a length of the space bit map of the third segment, and a field for indicating a position of the space bit map of the third segment.

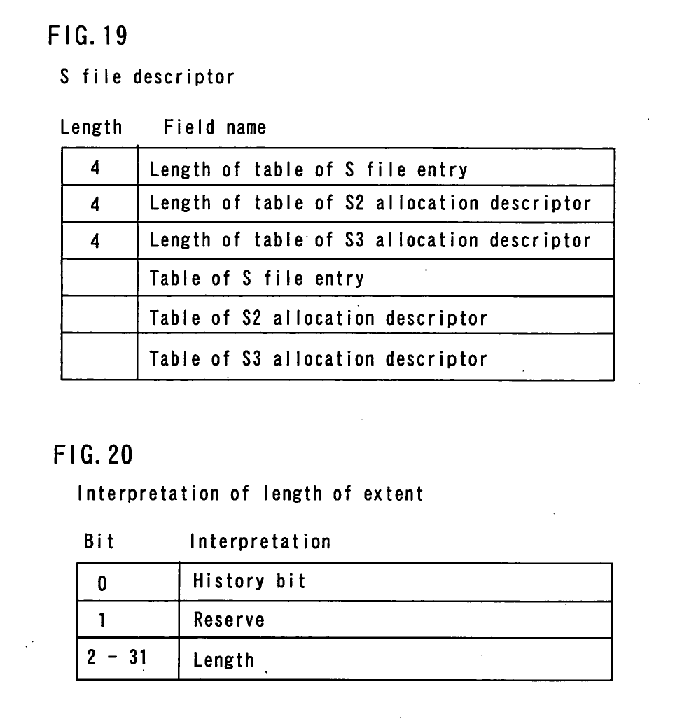

FIG. 19 indicates a data structure of the S file descriptor, which is a file structure to be recorded in the third ring area.

The S file descriptor includes a field for indicating a length of the table of the S file entry, and a field for indicating the length of the table of the S2 allocation descriptor, and a field for indicating the length of the S3 allocation descriptor. Following these fields, the S file descriptor further includes a field for indicating the table of the S file entry, the field for indicating the table of the S2 allocation descriptor, and the field for indicating the table of the S3 allocation descriptor.

FIG. 20 shows interpretation of bits to be recorded in the fields indicating the lengths of extents of the S2 allocation descriptor and the S3 allocation descriptor. The highest-order bit is a history bit. The history bit is set to be 1 only when the file and the directory managed with the S file descriptor indicated by the S integrity descriptor of the second area, which is one generation before, is deleted.

In one embodiment according to the present invention, as shown in FIGS. 4 through 7, 10 through 15 and 18 through 20, the information included in the UDF volume structure and the UDF file structure corresponds to “the first file management information which provides the first access method”, and the information included in the SVFS volume structure and the SVFS file structure correspond to “the second file management information which provides the second access method”. However, the information recorded in the information recording medium 100 is not limited to those shown in FIGS. 4 through 7, 10 through 15 and 18 through 20. The information recorded in the information recording medium 100 may be any type of information as long as it works as “the first file management information which provides the first access method” w and “the second file management information which provides the second access method” as described above.

2. Structure of Information Recording/Reproduction Apparatus

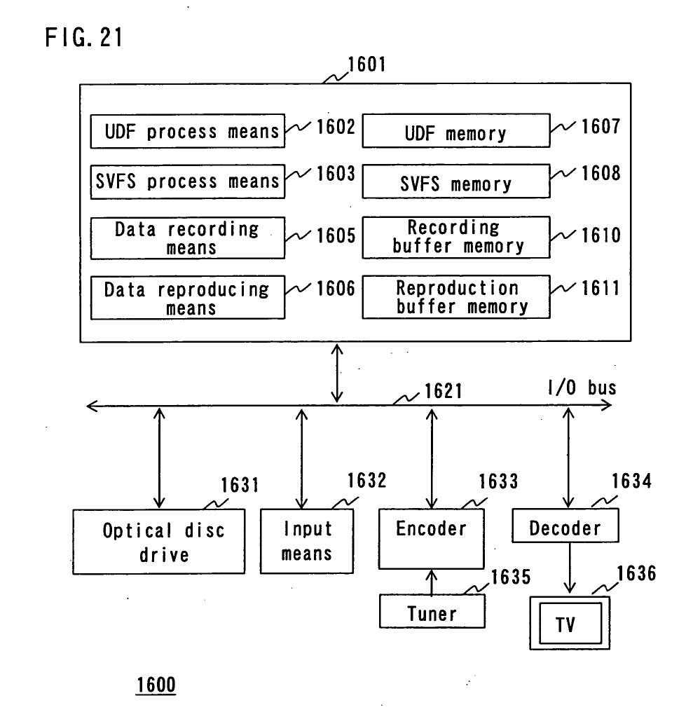

FIG. 21 indicates the structure of an information recording/reproduction apparatus 1600 according to an embodiment of the present invention.

The information recording/reproduction apparatus 1600 acts as an information recording apparatus which record information on the information recording medium 100 when a formatting process and file recording process are performed. Further, the information recording/reproduction apparatus 1600 acts as an information reproduction apparatus for reproducing information recorded on the information recording medium 100 when a file reproduction process is performed.

The information recording/reproduction apparatus 1600 includes a system control section 1601, an I/O bus 1621, an optical disc drive 1631, input means 1632 for inputting instruction information for recording and/or reproduction of files, a tuner 1635 for receiving TV broadcasting, an encoder 1633 for encoding an audio video signal selected at the tuner, a decoder 1634 for decoding the encoded audio video signal, and a TV 1636 for monitoring the audio video signal outputted from the decoder.

The system control section 1601 is implemented with a microprocessor including a control program of the system or an operation memory. More specifically, the system control section 1601 includes UDF process means 1602, SVFS process means 1603, a UDF memory 1607, and an SVFS memory 1608. The system control section 1601 further includes data recording means 1605, and a recording buffer memory 1610. The system control section 1601 further includes data reproducing means 1606, and a reproduction buffer memory 1611.

The UDF process means 1602 processes the UDF volume structure and file structure which are developed into the UDF memory 1607. When formatting is performed, the UDF process means 1602 generates the volume structure and required file structure. When a file is recorded, updated, or deleted, the UDF process means 1602 generates, alters, or delete the information managing the file. The UDF process means 1602 also generates the UDF file structure which manages the files of SPECIFIC directory and the following directories, which are to be recorded in a sequential area of the second segment and the third segment.

The SVFS process means 1603 processes the SVFS volume structure and file structure which are developed into the SVFS memory 1608. When formatting is performed, the SVFS process means 1603 generates the volume structure and required file structure. When a file is recorded, updated, or deleted, the UDF process means 1602 generates, alters, or deletes the information managing the file.

The data recording means 1605 instructs the optical disc drive 1631 to record data recorded in the recording buffer memory 1610 to a specific sector of the information recording medium 100.

The data reproducing means 1606 instructs the optical disc drive 1631 to read out data from the specific sector of the information recording medium 100 and transfer this data to the reproduction buffer memory 1611.

With the above-described structure, a recording/reproduction procedure is implemented. A personal computer system not always necessary to include the SVFS process means 1603 and the SVFS memory 1608. Further, in consumer equipment such as a video recorder, the UDF process means 1602 may be a simple process means which handles only the files of the SPECIFIC directory and the following directories.

3. Formatting Process

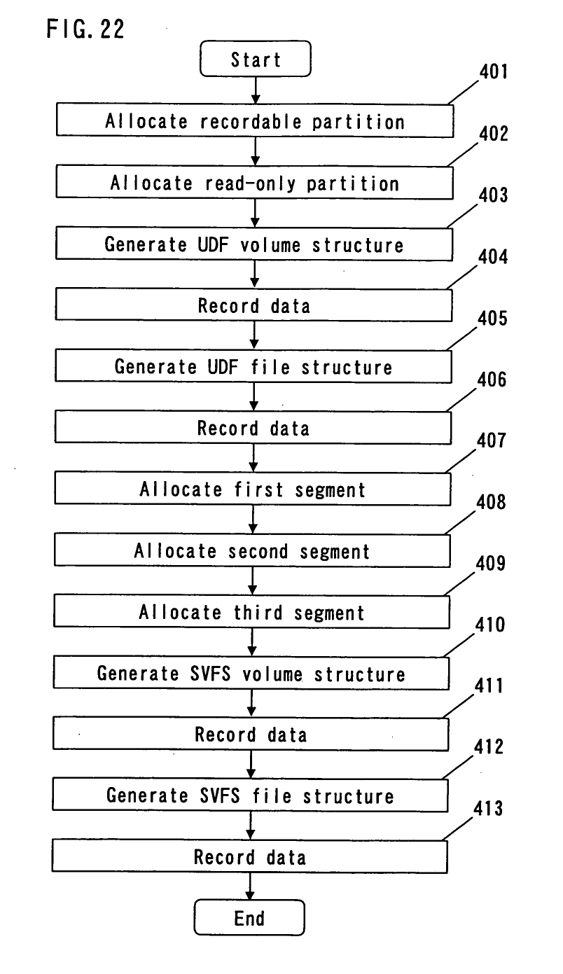

FIG. 22 shows a procedure of the formatting process. Hereinafter, the procedure of formatting process will be described step by step.

Step S401: The system control section 1601 decides a place to allocate the recordable partition which functions as the recordable area in view of the volume of the data to be recorded. After the place to allocate is decided, the process moves to step S402.

Step S402: The system control section 1601 decides a position to allocate the read-only partition which functions as the read-only area in view of the volume of data required to perform a predetermined application. After the place to allocate is decided, the process moves to step S403.

Step S403: The system control section 1601 generates the UDF volume structure for validating the recordable partition and the read-only partition. After the UDF volume structure is generated, the process moves to step S404.

Step S404: The optical disc drive 1631 records the generated UDF volume structure in the information recording medium. After the UDF volume structure is recorded in the information recording medium, the process moves to step S405.

Step S405: The system control section 1601 generates the UDF file structure to a root directory. After the UDF file structure is generated, the process moves to step S406.

Step S406: The optical disc drive 1631 records the generated UDF file structure on the information recording medium 100. After the UDF file structure is recorded in the information recording medium, the process moves to step S407.

Step S407: The system control section 1601 allocates the first segment such that the recordable partition and the first segment overlap. After the first segment is allocated, the process moves to step S408.

Step S408: The system control section 1601 allocates the second segment in the read-only partition in view of the volume of non-real time files used in a predetermined application. After the second segment is allocated, the process moves to step S409.

Step S409: The system control section 1601 allocates the third segment in the read-only partition in view of the volume of the real time files used in a predetermined application. After the third segment is allocated, the process moves to step S410.

Step S410: The system control section 1601 generates the S volume descriptor for validating the first segment, the second segment, and the third segment. Further, for performing ring recording, allocation positions of the first ring area and the slide area are decided and recorded in the S volume descriptor. After the S volume descriptor is generated, or the position information of the first ring area and the slide area is recorded in the S volume descriptor, the process moves to step S411.

Step S411: The optical disc drive 1631 records the SVFS volume structure in the first ring area. After the SVFS volume structure is recorded in the first ring area, the process moves to step S412.

Step S412: The system control section 1601 generates the SVFS file structure which includes the S file entry of the root directory. After the SVFS file structure is generated, the process moves to step S413.

Step S413: The optical disc drive 1631 records the SVFS file structure in the second ring area. After the SVFS file structure is recorded in the second ring area, the process ends. If the file structure cannot be recorded in the second ring area due to a presence of a defect sector, the file structure is recorded in the next area within the second ring area. If the file structure cannot be recorded even when the recording position is moved within the second ring area, the file structure is recorded in the next second ring area. In such a case, the S volume descriptor is updated for indicating that new second ring area is used, and the process moves to step S410, and then step S411.

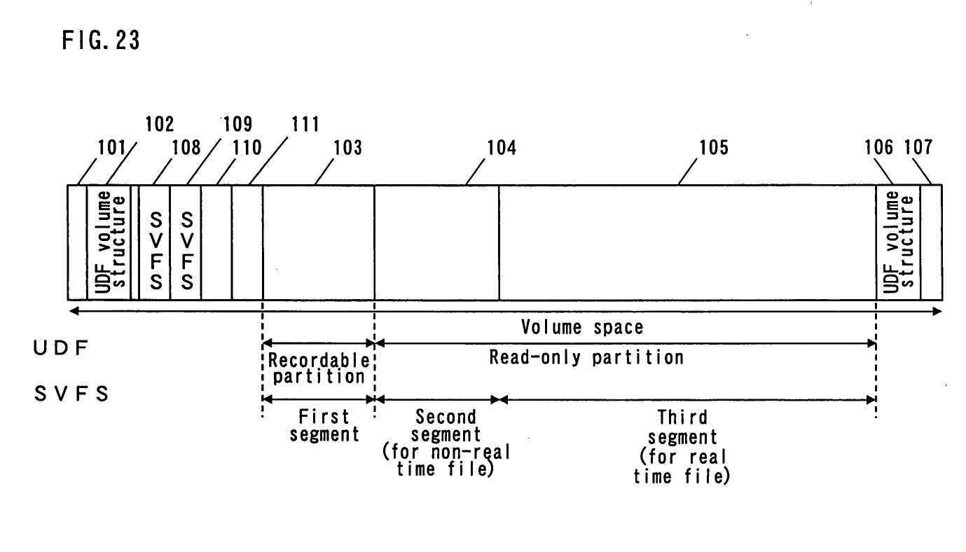

FIG. 23 shows a data structure of the information recording medium after the formatting process. By performing the above-described formatting-process to a “blank” information recording medium, the information recording medium having the data structure as shown in FIG. 23 is obtained.

4. File Recording Process

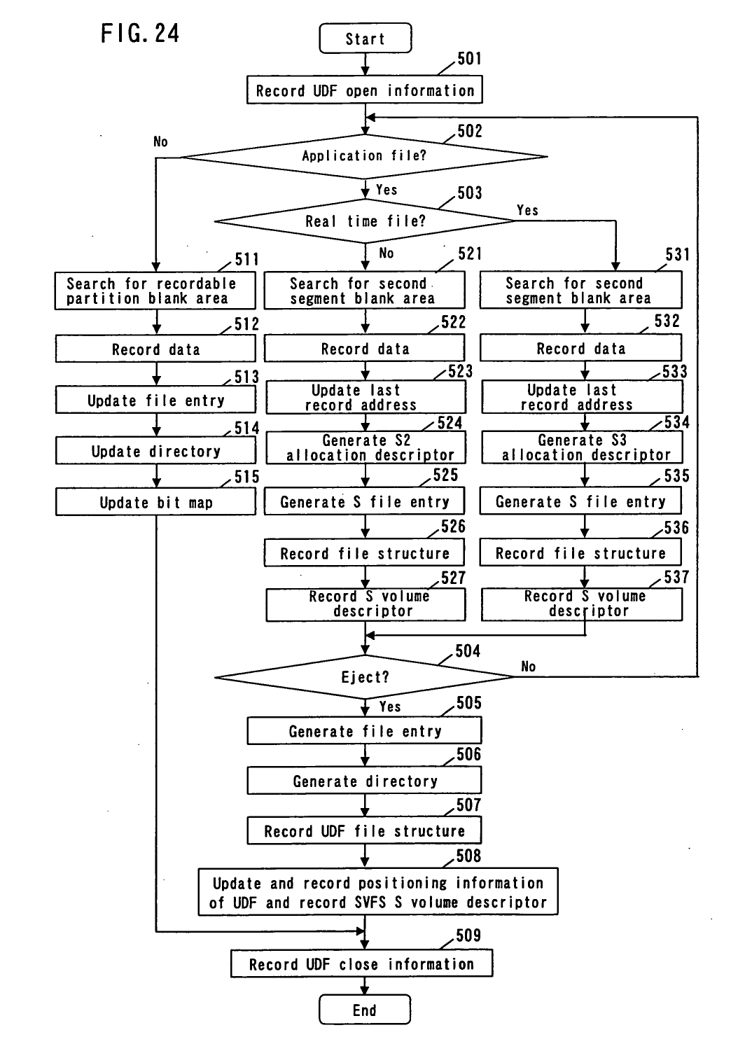

FIG. 24 shows a file recording process procedure. Hereinafter, the file recording process procedure will be described step by step.

Step S501: The system control section 1601 alters the logical volume integrity descriptor including open information such that a state of a logical volume managed by the UDF volume structure is the open state. After the logical volume integrity descriptor is altered, the process moves to step S502.

Step S502: The system control section 1601 determines whether the file to be recorded is a file to be used with a predetermined application, or a data file of the user. The system control section 1601 may obtain predetermined property information from the application to determine whether the file is the file to be used with the predetermined application, or may determine based on a file name. When the file to be recorded is the file to be used in the predetermined application, the process moves to step S503. When the file to be recorded is the data file of the user, the process moves to step S511.

A. Hereinafter, a file recording process procedure for the data file of the user will be described step by step. The file recording process procedure for the data file of the user will be described with reference to step S511 through step S515.

Step S511: The system control section 1601 checks for a blank area in the recordable partition in accordance with the space bit map included in the UDF volume structure. After the blank area is checked for, the process moves to step S512.

Step S512: The optical disc drive 1631 records the data file in the checked blank area. After the data file is recorded, the process moves to step S513.

Step S513: The system control section 1601 generates a file entry for the recorded file, and the optical disc drive 1631 records the file entry in the information recording medium. After the file entry is recorded, the process moves to step S514.

Step S514: The system control section 1601 updates the directory for registering the recorded file in the directory, and the optical disc drive 1631 records the updated directory in the information recording medium 100. Further, the system control section 1601 updates the file entry for managing the directory, and the optical disc drive 1631 records the updated file entry in the information recording media. After the updated file entry is recorded, the process moves to step S515.

Step S515: The system control section 1601 updates the space bit map for specifying the recorded area as the occupied area, and the optical disc drive 1631 records the updated space bit map in the information recording medium. After the updated space bit map is recorded, the process moves to step S509.

B. Hereinafter, a recording process procedure for a file used in a predetermined application will be described step by step. The recording process procedure for the file used in a predetermined application will be described with reference to steps S503, S521 through S527, and S531 through S537.

Step S503: The system control section 1601 determines whether the file to be recorded is a real time file or not. The system control section 1601 may obtain predetermined property information from the application for determining whether the file to be recorded is a real time file or not, or may determine based on a file name.

When the file to be recorded is not a real time file, the process moves to step S521. When the file to be recorded is a real time file, the process moves to step S531.

B-1. Hereinafter, a recording process procedure for a file which is not a real time file will be described step by step. The a recording process procedure for file which is not a real time file will be described with reference to steps S521 through S527.

Step S521: The system control section 1601 checks for a blank area of the second segment. If the space bit map of the second segment is included in the SVFS file structure, a blank area is checked for based on the space bit map. If the space bit map of the second segment is not included in the SVFS file structure, all the allocation descriptors included in the table of the S2 allocation descriptor are read out to check for a blank area of the second segment. After the blank area is checked for, the process moves to step S522.

Step S522: The optical disc drive 1631 records the data file in the checked blank area. After the data file is recorded, the process moves to step S523.

Step S523: The system control section 1601 generates an S volume descriptor with the last record address being updated for ring recording performed in the second segment. After the updated S volume descriptor is generated, the process moves to step S524.

Step S524: The system control section 1601 generates the S2 allocation descriptor for managing the recorded file. After the S2 allocation descriptor is generated, the process moves to step S525.

Step S525: The system control section 1601 generates the S file entry for registering the recorded file to the directory. After the S file entry is generated, the process moves to step S526.

Step S526: The optical disc drive 1631 records the SVFS file structure in the second ring area. After the SVFS file structure is recorded, the process moves to step S527.

Step S527: The optical disc drive 1631 records the SVFS volume structure in the first ring area. After the SVFS volume structure is recorded, the process moves to step S504.

B-2. Hereinafter, a recording process procedure for the real time file will be described step by step. The recording process procedure for the real time file will be described with reference to steps S531 through S537.

Step S531: The system control section 1601 checks for a blank area of the third segment. If the space bit map of the third segment is included in the SVFS volume structure, the blank area is checked for based on the space bit map. If the space bit map of the third segment is not included in the SVFS volume structure, all the allocation descriptors included in the S3 allocation descriptor table are read to check for the blank area of the third segment. After the blank area of the third segment is checked for, the process moves to step S532.

Step S532: The optical disc drive 1631 records the data file in the checked blank area. After the data file is recorded, the process moves to step S533.

Step S533: The system control section 1601 generates the S volume descriptor with the last record address being updated for ring recording performed in the third segment. After the updated S volume descriptor is generated, the process moves to step S534.

Step S534: The system control section 1601 generates the S3 allocation descriptor for managing the recorded file. After the S3 allocation descriptor is generated, the process moves to step S535.

Step S535: The system control section 1601 generates the S file entry for registering the recorded file in the directory. After the S file entry is generated, the process moves to step S536.

Step S536: The optical disc drive 1631 records the SVFS file structure in the second ring area. After the SVFS file structure is recorded, the process moves to step S537.

Step S537: The optical disc drive 1631 records the SVFS volume structure in the first ring area. After the SVFS volume structure is recorded, the process moves to step S504.

The recording process procedure for the data file of the user, the recording process procedure for the file to be recorded which is not a real time file, and the recording process procedure for the real time file are repeated until the recording process for the file to be recorded is finished.

Hereinafter, an ejecting process procedure will be described step by step. The ejecting process procedure will be described with reference to steps S504 through S509.

Step S504: The system control section 1601 determines whether the user finishes recording the file and instructs to eject the optical disc, or instructs to record a next file.

If ejection is not instructed, the process enters a waiting state. If ejection is instructed, the process moves to step S505. If recording of the next file is instructed, the process moves to step S502.

Step S505: For making the files recorded in the second segment or the third segment readable in accordance with the UDF file structure, the system control section 1601 generates the UDF file entry regarding these files as a process upon ejection. After the UDF file entry is generated, the process moves to step S506.

Step S506: The system control section 1601 further generates the directory file and the file entry thereof for registering these files in the directory. After the directory file and the file entry are generated, the process moves to step S507.

Step S507: The system control section 1601 updates the UDF file structure of the SPECIFIC directory and the following directories generated in steps S505 and S506, and the optical disc drive 1631 records the updated UDF file structure in the information recording medium. After the UDF file structure is recorded, the process moves to step S508.

Step S508: The system control section 1601 updates and records the SVFS recording descriptor for recording position information of the newly updated UDF file structure in the recording descriptor.

Step S509: The system control section 1601 alters the logical volume integrity descriptor including close information such that the state of the logical volume controlled by the UDF volume structure becomes the closed state, and the optical disc drive 1631 records the altered logical volume integrity descriptor in the information recording media. After the logical volume integrity descriptor is recorded, the process ends.

The recording process procedure for the data file of the user is performed with the system employing UDF. The system employing UDF is, for example, a personal computer system. The recording process procedure for the file used in a predetermined application and the ejecting process procedure are performed with the system employing SVFS. The system employing SVFS is, for example, consumer equipment such as a video recorder.

In an embodiment according to the present invention shown in FIG. 24, step S511, S521 or S531 corresponds to a “step for reading out one of the first file management information and the second file management information”, step S512, S522 or S532 corresponds to a “step for accessing the data area with an access method provided by one of the read out first file management information and the second file management information”, and steps S507 and S508 correspond to a “step for updating the first file management information and the second file management information so as to correspond record position of the file”. However, the recording process procedure for the file is not limited to that shown in FIG. 24. The recording process procedure for the file may include any process procedure as long as it has functions of the “step for reading out one of the first file management information and the second file management information”, the “step for reading out one of the first file management information and the second file management information”, and the “step for updating the first file management information and the second file management information so as to correspond record position of the file” described above.

By performing the recording process procedure for the file on the information recording medium having the data structure shown in FIG. 23, information recording medium having the data structure shown in FIG. 1 is obtained.

5. File Reproducing Process

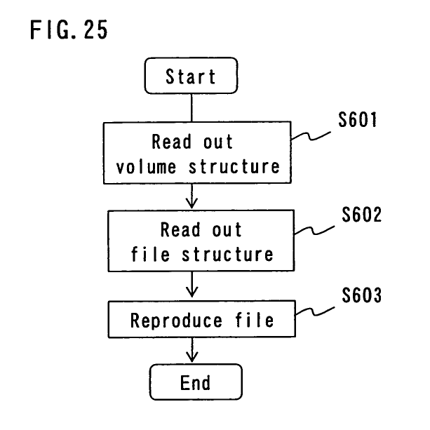

FIG. 25 shows a file reproducing process procedure. Hereinafter, file reproducing process procedure will be described step by step.

Step S601: When it is detected that the information recording medium 100 is inserted into the optical disc drive 1631, the system control section 1601 reads out one of the UDF volume structure and the SVFS volume structure. After the volume structure is read out, the process moves to step S602.

Step S602: The system control section 1601 reads out one of the UDF file structure and the SVFS file structure in accordance with the read out volume structure. After the file structure is read out, the process moves to step S603.

Step S603: The system control section 1601 reproduces the files recorded in the information recording medium 100 with the first access method or the second access method in accordance with the read out file structure. After the file is reproduced, the process ends.

In the embodiment shown in FIG. 25, steps S601 and S602 correspond to the “step for reading out one of the first file management information and the second file management information”, and step S603 corresponds to the “step for accessing the data area with an access method provided by one of the read out first file management information and the read out second file management information”. However, the file reproducing process procedure is not limited to that shown in FIG. 25. The file reproducing process procedure may include any process procedure as long as it has the functions of the “step for reading out one of the first file management information and the second file management information” and the “step for accessing the data area with an access method provided by one of the read out first file management information and the read out second file management information”.

6. File Recording/Deleting Process Using History Bits

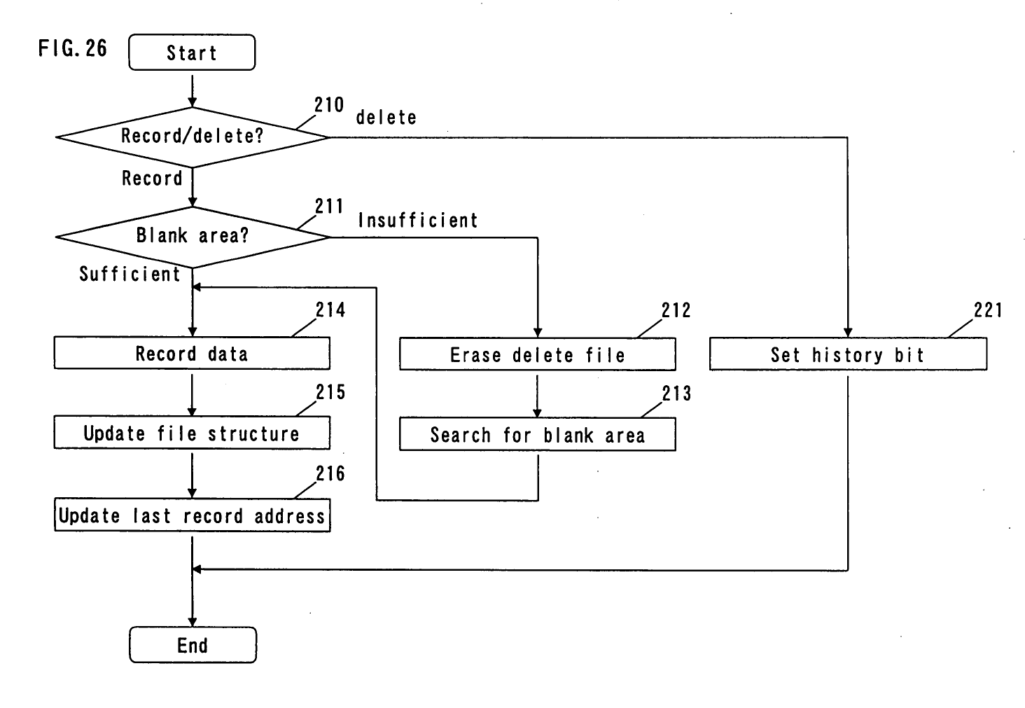

FIG. 26 shows a recording/deleting process procedure using history bits according to the present invention. Hereinafter, recording/deleting process procedure using history bits will be described step by step.

Step S210: The system control section 1601 determines whether to perform the recording process for the file, or the deleting process for the file. For recording the files, the process moves to step S211. For deleting the files, the process moves to step S221.

Step S211: The optical disc drive 1631 searches for a blank area from a predetermined position. The optical disc drive 1631 checks for the blank area, for example, from the last record address toward the outer periphery. If a blank area having a required size is not found, the process moves to step S212. If a blank area having a required size is found, the process moves to step S214.

Step S212: The system control section 1601 deletes file management information of the delete file with the history bit being set to release the area secured by the delete file. After the area is released, the process moves to step S213.

Step S213: The optical disc drive 1631 again checks for a blank area from the predetermined position, and finds a blank area. If the blank area is not found after search to the outer periphery, search is started from the inner periphery. After the blank area is found, the process moves to step S214.

Step S214: The optical disc drive 1631 records data in the found blank area. After the data is recorded, the process moves to step S215.

Step S215: The system control section 1601 updates the file structure for registering the recorded file in the directory. After the file structure is updated, the process moves to step S216.

Step S216: The system control section 1601 updates the last record address for updating the position of a pointer where the search for a blank area is started. After the last recording address is updated, the process ends.

Step S221: The system control section 1601 sets the history bits while securing the area of the file to be deleted. After the history bits are set, the procedure ends.

By performing recording/deleting process procedure using history bits, files can be recorded preferentially from the blank area deleted two generations before. Thus, it is possible to save a file of one generation before, and return to the area of one generation before. Further, it can be prevented that the same area is deleted and updated for many generations.

In the UDF file system, the delete bit is set in the file identifier descriptor. However, for setting the bit, the file entry of the delete file has to be deleted. Thus, for performing the recording/deleting process procedure using history bits, it is effective to introduce the SVFS file system.

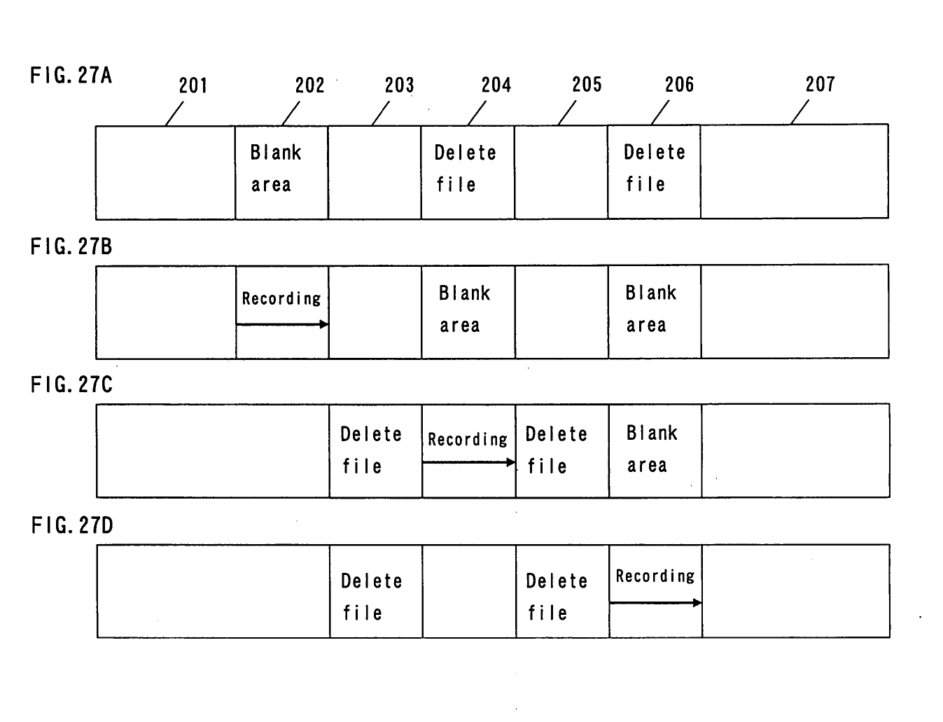

FIG. 27 shows an example of the area in/from which the file is recorded/reproduced by using the recording/deleting process procedure using history bits according to the present invention.

In areas (a) through (d), areas 201 through 207 are respectively allocated. Areas (a) through (d) illustrate transition in file recording into the area.

In area (a), areas 201, 203, 205 and 207 are already occupied with recorded data. The area 202 illustrates a blank area. Areas 204 and 206 are areas in which the deleted files are recorded. By setting the history bits to the areas 204 and 206, they are distinguished from a blank area.

For recording the file in area (a), a blank area is searched for from the last record address toward the outer periphery. As a result of the search, data is recorded in the area 202. For further recording the file, the areas 204 and 206 with the history bits set therein are release to be blank areas since blank is insufficient. As a result of recording files in area (a), area (b) is obtained.

For recording the file in area (b), a blank area is searched for from the last record address toward the outer periphery. As a result, data is recorded in the area 204. Then, the files recorded in the areas 203 and 205 are deleted. As a result of recording files in area (b), area (c) is obtained.

For recording the file in area (c), since the areas from which the file has been just deleted is secured, the file is not recorded in these areas but in the blank area 206. As a result of recording files in area (c), area (d) is obtained.

According to the present invention, one of the first file management information which provides the first access method and the second file management information which provides the second access method is read out, and the data area allocated in the information recording medium with the access method provided by one of the first file management information and the second file management information which has been read out. Therefore, different access methods are provided in the case where the first file management information is read out and in the case where the second file management information is read out.

For example, the first access method is a method for accessing a data area such that the data area functions as a read-only area which allows only the reproduction of the files recorded in the data area, and the second access method is a method for accessing a data area such that the data area functions as an area which allows the reproduction of the file recorded in the data area and also recording of the file in the data area.

Therefore, it is possible to read out the files recorded in the data areas, and record files in the data areas by using an apparatus which can read out the second file management information. On the other hand, it is possible to prevent recording of a file into the data areas by using an apparatus which can read out the first file management information.

As a result, the compatibility between the UDF volume structure and the SVFS volume structure, and the compatibility between the UDF file structure and the SVFS file structure can be maintained.

### Embodiment 2

In Embodiment 2 according to the present invention, an example in which a volume space is used as one partition while an area in which file is recordable in accordance with the UDF file system is secured. Using one partition enables the UDF file system which cannot recognize a plurality of partitions to reproduce the files recorded in the information recording medium.

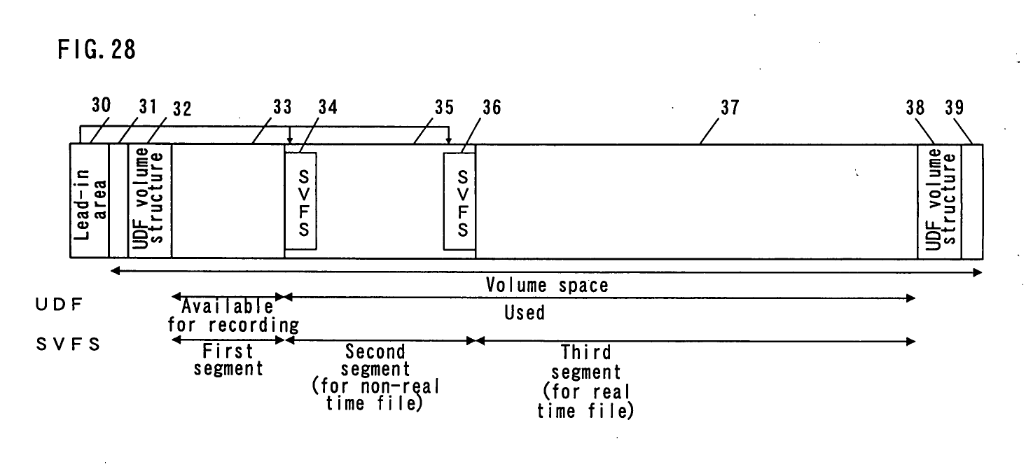

FIG. 28 shows a data structure of the information recording medium after the formatting process.

In the information recording medium after the formatting process, areas 30 through 39 are allocated. The areas 31 and 39 are unused areas. In the area 32 on the inner peripheral side of the information recording medium, and the area 38 on the outer peripheral side of the information recording media, the UDF volume structures are recorded. In the UDF file system, an area formed of the area 33, 35, and 37 is defined as one recordable partition. In accordance with the space bit map descriptor for managing blank areas in the partition, bit maps of the sectors are set such that the area 33 is a recordable area, the area 34 through 37 are used areas.

The SVFS volume structure and file structure are recorded in the areas 34 and 35. The areas 34 and 36 are defined as used areas in accordance with the UDF file structure. The record position of the SVFS volume structure and file structure recorded in the areas 34 and 35 are recorded in a lead-in area 30. By recording the record position of the SVFS volume structure and file structure, the areas in which the SVFS volume structure and file structure are recorded are no longer necessary to be fixed area. Therefore, when the volume structure or SVFS file structure is destroyed, an area in which the SVFS volume structure and file structure are recorded can be newly recorded.

The SVFS file system manages the area 33 which is recordable in accordance with the UDF file structure as the first segment, the area in which the file including information for controlling the real time data as the second segment, and the area in which the real time file is recorded as the third segment.

Further, the area 33 is managed as the area which is not recorded in accordance with the SVFS file structure. The second segment and the third segment are managed as the areas recordable in accordance with the SVFS file structure.

To conform to the UDF file system, the recordable area is designated by the space bit map descriptor. Since a blank area is only in the area 33, a new file is recorded in the area. Although the space bit map descriptor is not shown in the figure for the sake of the simplicity of the explanation, the space bit map descriptor is recorded, for example, next to the file set descriptor.

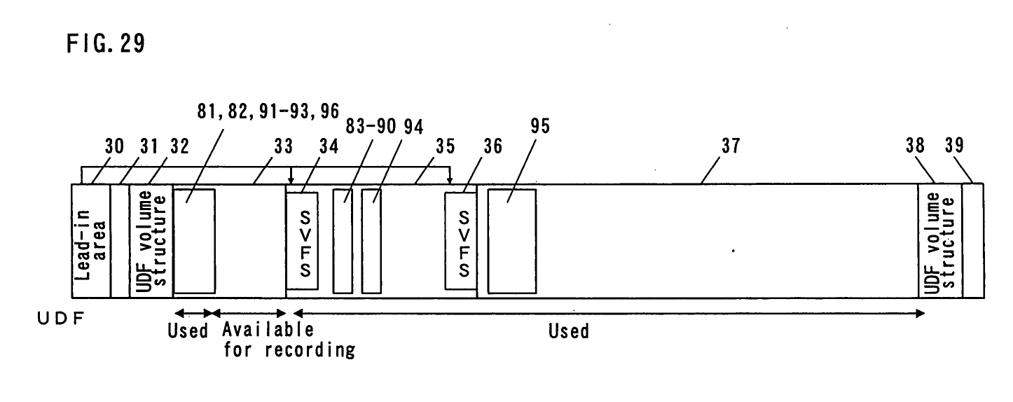

FIG. 29 shows a data structure of the information recording medium following the recording of files in the information recording medium after the formatting process shown in FIG. 28.

Among the UDF file structures shown in FIG. 3, the file structures until the root directory, and the file structure of the USR directory and the following directories are recorded in the UDF recordable area 33. Thus, the user can record, update, and delete the user file in accordance with the UDF file structure.

The files recorded in the second segment and the third segment may be deleted in accordance with the UDF file structure unless a deleting prohibition bit or the like is designated. For example, if RT_{—}001.RTS file is deleted, an area in which the file in the third segment is registered in the space bit map descriptor of the UDF volume structure as the recordable area. Thus, since it cannot predict what kind of operation the user performs, it is assumed that the compatibility of the UDF volume structure and the SVFS volume structure, and the compatibility between the UDF file structure and the SVFS file structure may be lost. Therefore, when data is recorded in the second segment or the third segment, equipment which supports the SVFS file system needs to check whether the file structure of the SPECIFIC directory and the following directories beforehand with a predetermined method.

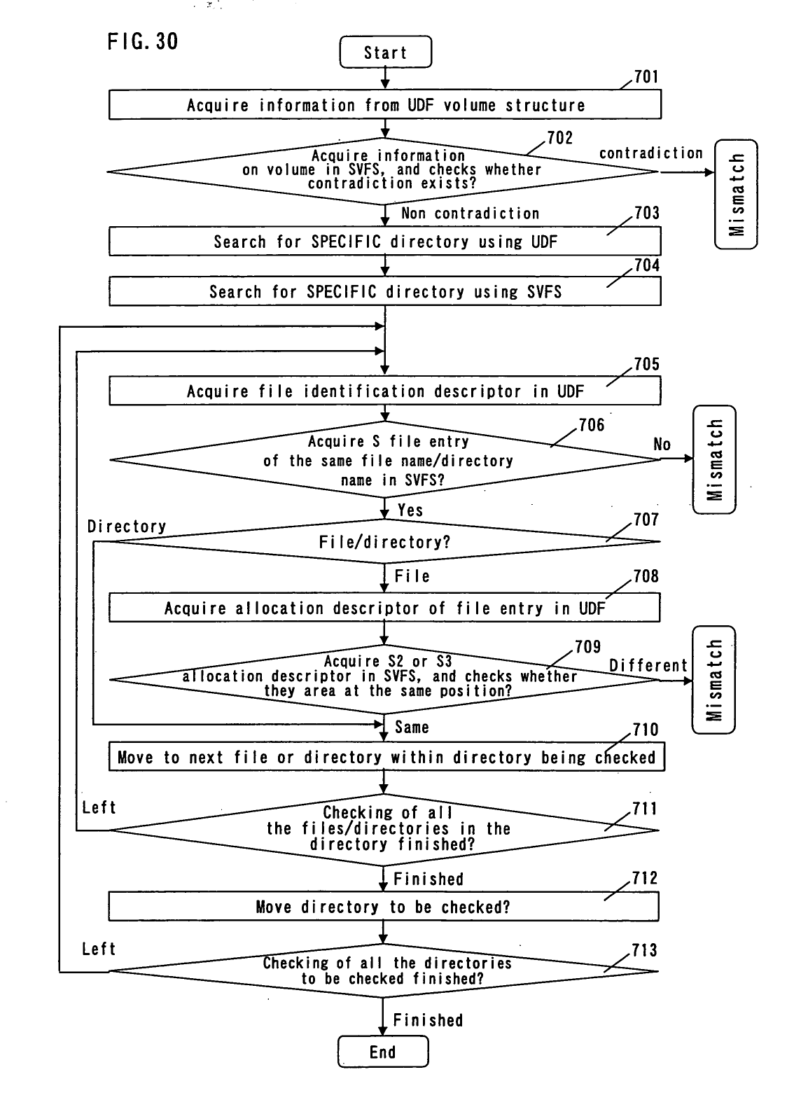

FIG. 30 shows a compatibility checking process for the UDF volume structure and the SVFS volume structure, and a compatibility checking process for the UDF file structure and the SVFS file structure. Hereinafter, the compatibility checking process will be described step by step with reference to FIGS. 30 and 3.

Step S701: The optical disc drive 1631 reads out the UDF volume structure 80. The system control section 1601 acquires information on volume such as a position of the partition based on the read out UDF volume structure. After the information on the volume is acquired, the process moves to step S702.

Step S702: The optical disc drive 1631 reads out the SVFS S volume descriptor 151. Based on the read out SVFS S volume descriptor 151 and the read out UDF volume structure, the system control section 1601 checks whether there is a contradiction in the information indicating the record position of the information included in the volume structure, the information for indicating the recording time of the information included in the volume structure, and information indicating the name of the information included in the volume structure.

Checking whether there is a contradiction in the information indicating the record position of the information included in the volume structure or not is performed as follows.

The system control section 1601 checks whether there is a contradiction in the information of the partition recorded in the UDF volume structure 80, and the information of the segment recorded in the S volume descriptor 151. If the recordable partition is recorded, the system control section 1601 checks whether the read-only partition is same as the area formed of the second segment and the third segment or not. If the first segment which is not accessed from the recordable partition and SVFS is not set, the system control section 1601 checks whether the segment of non-real time file and the segment of the real time file are same area as the read-only partition or not.

Checking whether there is a contradiction in the information for indicating the recording time of the information included in the volume structure is performed or not is performed as follows.

The system control section 1601 checks whether the recording time and the implementer ID of the logical volume integrity descriptor match the recording time and the implementer ID of the recording descriptor.

Checking whether there is a contradiction in the information indicating the name of the information included in the volume structure or not is performed as follows.

The system control section 1601 checks whether a volume name of a UDF primary volume descriptor and a volume name of the S volume descriptor are the same.

By performing step S702, the system control section 1601 can check the compatibility related to the volume structure. If there is no contradiction in the information included in the volume structure, the process moves to step S703. If there is a contradiction in the information included in the volume structure, it is determined that the information included in the volume structure has a mismatch.

Step S703: The system control section 1601 searches the UDF file structure, and finds the SPECIFIC directory. The Root directory includes not only a SPECIFIC directory but also a USR directory. However, since the files registered in the USR directory are not handled by the SVFS file system, it is not checked with respect to the compatibility, and the SPECIFIC directory and the following directories are checked. After the volume structure 80 is processed, the UDF file system searches the file set descriptor 81, the file entry 82, the file entry 83, the SPECIFIC directory, sequentially. After the search, the process moves to step S704.

Step S704: The system control section 1601 searches the SVFS file structure, and finds the S file entry of the SPECIFIC directory. The system control section 1601 sequentially searches the S volume descriptor 151, the recording descriptor 152, the S file entry 153 of Root directory, and the S file entry 154 of SPECIFIC directory. After the search, the process moves to step S705.

Step S705: The system control section 1601 acquires the file identifier descriptor in order to check the compatibility of the file or directory sequentially from the header of SPECIFIC directory.

Step S706: The system control section 1601 sequentially checks whether there is an S file entry having the file name or the directory name which matches the file name or the directory name recorded in the file identifier descriptor. The S file entry of the file included in the directory or the directory which is to be checked can be read out by following an S file entry indicated by a child entry number of the S file entry of the directory which is to be checked, and an S file entry indicated by an entry number of a brother of the S file entry, and an S file entry indicated by an entry number of a brother different from the S file entry indicated by the entry number of the brother. In the UDF file structure, the directory also includes a file identifier descriptor indicating a parent directory. An S file entry corresponding to the file identifier descriptor indicating the parent directory is an S file entry indicated by the entry number of the parent in the SVFS file structure.

If there is no matching S file entry, it is determined to be a mismatch. If there is a matching S file entry, the process moves to step S707.

Step S707: The system control section 1601 determines whether it is currently checking a directory or checking a file. If it is currently checking a directory, the process moves to step S710. If it is currently checking a file, the process moves to step S708.

Step S708: The system control section 1601 acquires the allocation descriptor of the file entry, which is the position information of the file managed by the UDF file structure. After the allocation descriptor is acquired, the process moves to step S709.

Step S709: The system control section 1601 acquires the S2 allocation descriptor or the S3 allocation descriptor from entry numbers in the table of the S2 allocation descriptor or the tables of the S3 allocation descriptor included in the SVFS file structure. Based on the allocation descriptor UDF file structure and the S2 allocation descriptor or S3 allocation descriptor, the system control section 1601 checks whether the record positions of the file are the same or not. If they are not the same, it is apparent that the file is altered in accordance with only one of the UDF file system or the SVFS file system. If they are the same, the process moves to step S710.

Step S710: The system control section 1601 changes the subject to be checked to the next file in the directory being checked or the next directory in accordance with the UDF file structure. After the subject is changed, the process moves to step S711.

Step S711: The system control section 1601 determines whether checking of all the files or the directory is finished in the directory being checked. When it is determined that the checking is finished, the process moves to step S712. If it is determined that the process is not finished, the process moves to step S705.

Step S712: The system control section 1601 changes the subject to be checked to a directory which has not been checked yet. After the subject is changed, the process moves to step S713.

Step S713: The system control section 1601 determines whether checking of the files in all of the SPECIFIC directory and the following directories is completed. If the checking is completed, the process ends. If the checking is not completed, the process moves to step S705.

The UDF file entries of the SPECIFIC directory and the following directories and the file identifier descriptor are recorded in a continuous area. Since position information of the UDF file entries of the SPECIFIC directory and the following directories and the file identifier descriptor are managed by fields for indicating the length and the position of the specific UDF file structure of the recording descriptor, in the case where the corresponding file entry, or the file identifier descriptor is recorded in a area outside this area, it can determine that these file structures are rewritten. Further, since the dates of modification of these file entries are recorded at the same time in accordance with the SVFS file system, it can be determined whether it is rewritten in accordance with the UDF file system by checking the information of the date of modification.

According to Embodiment 2 of the present invention, the compatibility between the file system and the compatibility between the SVFS file system can be maintained by equipment supporting the SVFS file system.

The procedure in which the compatibility is checked in the order of the directories registered in the UDF file structure. However, the compatibility may be checked in turn of the directories registered in the SVFS file structure.

The procedure of compatibility checking process for the UDF volume structure and the SVFS volume structure, and the compatibility checking process for the UDF file structure and the SVFS file structure are also effective in Embodiment 1. For example, in the case where data is recorded in accordance with the SVFS file system, and power supply is shut off while the UDF file structure is being updated, causing the recording to stop, the compatibility between the UDF volume structure and the SVFS volume structure or the compatibility between the UDF file structure and the SVFS file structures are lost. In such a case, a file without compatibility can be found in accordance with the above process procedure.

### Embodiment 3

In Embodiment 3 according to the present invention, an example in which an information recording medium in which a file including a core set file and an extension set file is recorded will be described.

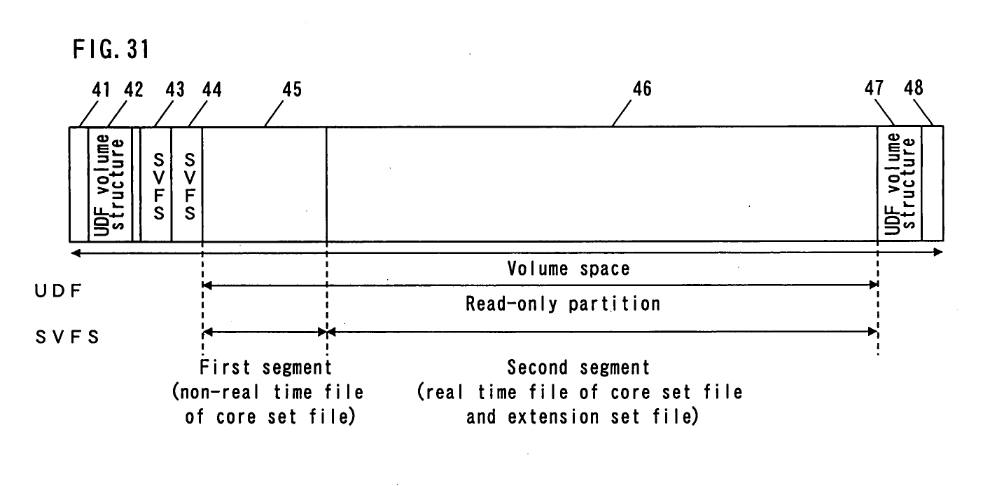

FIG. 31 shows a data structure of the information recording medium in which the file including the core set file and the extension set file.

In the information recording medium, areas 41 through 48 are allocated. The areas 41 and 48 are unused areas. The UDF volume structures are recorded in the area 42 at the inner peripheral side of the information recording medium and the area 47 at the outer peripheral side of the information recording medium. The SVFS volume structure and the SVFS file structure are recorded in the areas 43 and 44. In the UDF file system, the areas 45 and 46 are defined as one read-only partition. In the SVFS file system, the area 45 is defined as the first segment, and the area 46 is defined as the second segment.

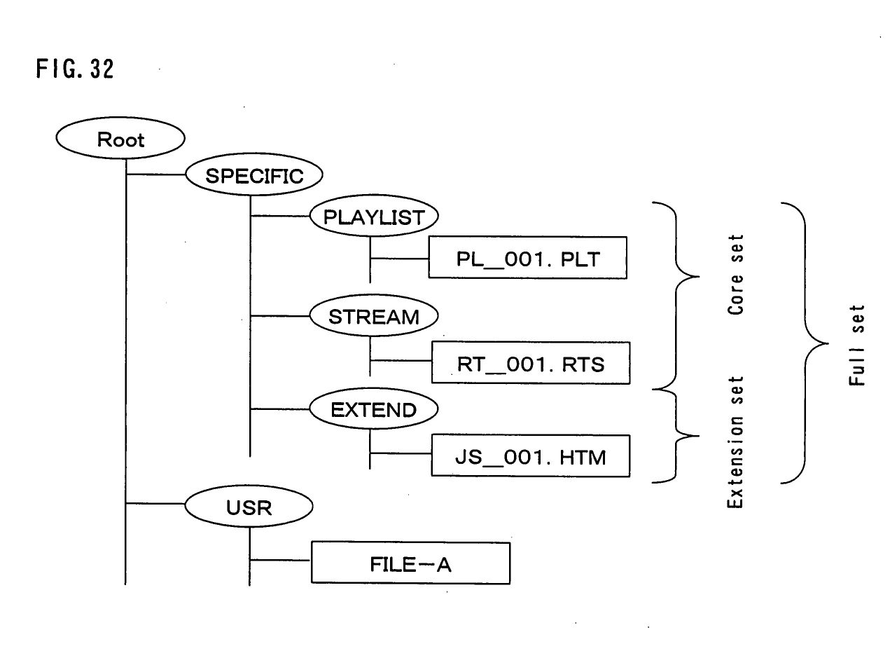

FIG. 32 shows a directory structure. The directory structure shown in FIG. 2 and the directory structure shown in FIG. 32 have the same structure except that an EXTEND directory is added to the SPECIFIC directory.

A control file for performing basic reproduction of video data is recorded in the PLAYLIST directory and the following directories. A file for interactivity or for performing a complicated reproduction operation is recorded in the EXTEND directory. The data recorded in the directory may be control data expressed in a script language such as JavaScript, control data executed via a network such as Internet, small still image data or audio data controlled by a script language, or the like.

In the directory structure shown in FIG. 32 includes a core set file, extension set file, and a full set file. The core set file is a file for implementing basic functions of a predetermined application. The extension set file is a file for implementing extended functions of a predetermined application. The full set file includes the core set file and the extension set file. For example, all the files recorded in the SPECIFIC directory are full set files, the files recorded in the PLAYLIST directory and the STREAM directory are the core set files, and the files recorded in the EXTEND directory are the extension set files.

Read-only players for consumer use which have small CPU power and/or available memory can perform reproduction operations using only the core set files. In PCs and sophisticated AV equipment which can provide reproduction of substantial and interactive video/audio contents, the directory structure is set such that the reproduction operation can be performed using the full set files.

Among the core set files, a non-real time file such as control data is recorded in the first segment. Among the core set files, the real time file, and the extension set file, and the data file recorded in the USR directory are recorded in the second segment.

The SVFS volume structure and file structure are set such that, among the SPECIFIC directory, the files recorded in the PLAYLIST directory and the STREAM directory are reproduced in accordance with the SVFS file system. The UDF volume structure and file structure are set such that all the files are reproduced in accordance with the UDF file system.

Since the number of the files related to JavaScript is large, the size of the SVFS data structure can be reduced by registering only the core set files to the SVFS file structure. Thus, consumer equipment which supports basic functions can be performed at low cost.

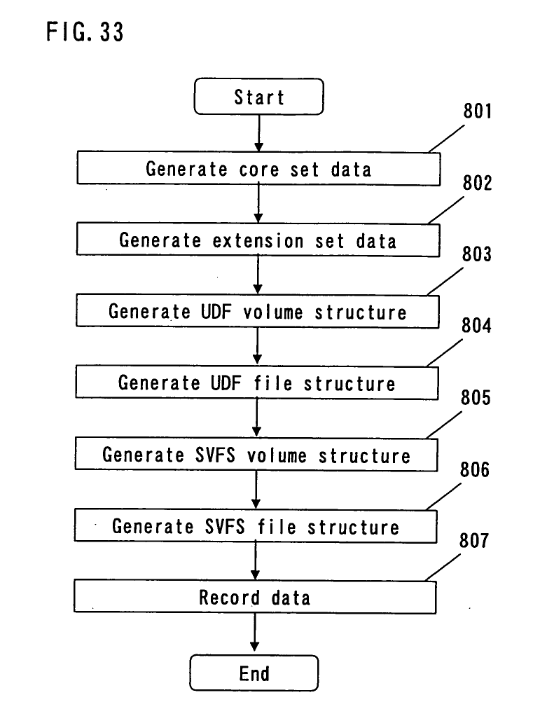

FIG. 33 shows a procedure for producing the information recording medium in which the files including the core set file and the extension set file are recorded will be described. Hereinafter, procedure for producing the information recording medium in which the files including the core set file and the extension set file are recorded will be described step by step.

Step S801: A producer of the contents generates data of the core set file so as to implement basic reproduction functions. After the data of the core set file is generated, the process moves to step S802.

Step S802: The producer of the contents generated data of the extension set file so as to implement more substantial reproduction function. After the data of the extension set file is generated, the process moves to step S803.

Step S803: The system control section 1601 generates the UDF volume structure for allocating the read-only partition to the information recording medium. After the UDF volume structure is generated, the process moves to step S804.

Step S804: The system control section 1601 generates the UDF file structure such that the files are in predetermined locations. After the UDF file structure is generated, the process moves to step S805.

Step S805: The system control section 1601 generates the SVFS volume structure for allocating the first segment, and the second segment to the information recording medium. After the SVFS volume structure is generated, the process moves to step S806.

Step S806: The system control section 1601 generates the SVFS file structure such that it may access the area in which the core set file is recorded in accordance with the SVFS file system. After the SVFS file structure is generated, the process moves to step S807.

Step S807: The data generated by performing steps S801 and S802 are recorded in the information recording medium. After the data is recorded in the information recording medium, the process ends.

If the information recording medium is of a read-only type, the information recording medium in which data is recorded using a disc production apparatus such as a stamper. If the information recording medium is of a write once read many type, data generated by performing steps S801 through S802 using an optical disc drive is sequentially recorded, and the information recording medium of a read-only type is produced.

Although, in the above-described Embodiment 3, the case where the data areas including the data to be reproduced are defined as the read-only partition and the read-only segment has been described as an example, the present invention is not limited to this.

The access method provided by the UDF volume structure and file structure is a method for accessing the data areas so as to reproduce the core set file and the extension set file included in the files recorded in the data area. The access method provided by the SVFS volume structure and the SVFS file structure is a method for accessing the data areas so as to reproduce only the core set file among the core set file and the extension set file included in the files recorded in the data area. As long as these conditions are met, the present invention is applicable even when the data areas including the data to be reproduced are defined as the recordable partition and the recordable segment. The present invention is also applicable even when the data area including the data to be reproduced is defined as the recordable partition and the read-only segment. The present invention can also be applied even when the data area including the data to be reproduced is defined as the read-only partition and the recordable segment.

According to the present invention, one of the first file management information which provides the first access method and the second file management information which provides the second access method is read out, and the data area allocated to the information recording medium is accessed with the access method provided by one of the read out first file management information and the read out second file management information. Thus, different access methods are provided for the case where the first file management information is read out, and the second file management information is read out.

For example, the first access method is a method for accessing the data area so as to reproduce the core set file included in the file recorded in the data area (file for implementing basic functions of a predetermined application) and the extension set file (file for implementing extended functions of a predetermined application), and the second access method is a method for accessing the data area so as to reproduce only the core set file among the core set file and the extension set file included in the file recorded in the data area.

Therefore, an apparatus which can read out the first file management information can implement basic functions and extension functions of a predetermined application. An apparatus which can read out the second file management information can only implement basic functions of a predetermined application.

As a result, read-only players for consumer use which have a small CPU power and/or available memory can perform a reproduction operation by using only the core set file. PCs and sophisticated AV equipment which can provide reproduction of substantial and interactive video/audio contents can perform a reproduction operation using the full set.

### INDUSTRIAL APPLICABILITY

According to the present invention, one of the first file management information which provides the first access method and the second file management information which provides the second access method is read out, and the data area allocated to the information recording medium is accessed with the access method provided by one of the read out first file management information and the read out second file management information. Thus, different access methods are provided for the case where the first file management information is read out, and the second file management information is read out.

(1) For example, the first access method is a method for accessing a data area such that the data area functions as a read-only area which allows only the reproduction of the files recorded in the data area, and the second access method is a method for accessing a data area such that the data area functions as an area which allows the reproduction of the file recorded in the data area and also recording of the file in the data area.

Therefore, it is possible to read out the files recorded in the data areas, and record files in the data areas by using an apparatus which can read out the second file management information. On the other hand, it is possible to prevent recording of a file into the data areas by using an apparatus which can read out the first file management information.

As a result, the compatibility between the UDF volume structure and the SVFS volume structure, and the compatibility between the UDF file structure and the SVFS file structure can be maintained.

(2) For example, the first access method is a method for accessing the data area so as to reproduce the core set file included in the file recorded in the data area (file for implementing basic functions of a predetermined application) and the extension set file (file for implementing extended functions of a predetermined application), and the second access method is a method for accessing the data area so as to reproduce only the core set file among the core set file and the extension set file included in the file recorded in the data area.

Therefore, an apparatus which can read out the first file management information can implement basic functions and extension functions of a predetermined application. An apparatus which can read out the second file management information can only implement basic functions of a predetermined application.

As a result, read-only players for consumer use which have a small CPU power and/or available memory can perform a reproduction operation by using only the core set file. PCs and sophisticated AV equipment which can provide reproduction of substantial and interactive video/audio contents can perform a reproduction operation using the full set.

1. A method for accessing an information recording medium in which a data area is allocated, wherein:
first file management information which provides a first access method and second file management information which provides a second access method are recorded in the information recording medium; and
the first file management information and the second file management information manage files recorded in the information recording medium, the method comprising the steps of:
(a) reading out one of the first file management information and the second file management information; and
(b) accessing the data area with the access method provided by one of the read out first file management information and the read out second file management information.

2. A method according to claim 1, wherein:
the first access method is a method for accessing the data area such that the data area functions as a read-only area which allows only reproduction of a file recorded in the data area; and
the second access method is a method for accessing the data area such that the data area functions as an area which allows reproduction of the file recorded in the data area, and also recording of a file in the data area.

3. A method according to claim 1, wherein:
the file recorded in the data area includes a core set file and an extension set file;
the core set file is a file for implementing a basic function of a predetermined application;
the extension set file is a file for implementing an extended function of the predetermined application;
the first access method is a method for accessing the data area so as to reproduce the core set file and the extension set file included in the files recorded in the data area;
the second access method is a method for accessing the data area so as to reproduce only the core set file among the core set file and the extension set file included in the files recorded in the data area.

4. A method according to claim 1, wherein:
at least one partition which is defined as an area accessible with the first access method and at least one segment which is defined as an area accessible with the second access method are allocated in the information recording medium; and
the data area is an overlap area in which parts of the at least one partition and the at least one segment overlap each other.

5. A method according to claim 4, wherein:
the segment includes a first segment and a second segment; and
an area formed of the first segment and the second segment and the partition overlap each other.

6. A method according to claim 4, wherein the partition and the segments are allocated in ECC block units.

7. A method according to claim 1, wherein the step (b) includes the step of recording a file in the data area, the method further comprising the step of:
(c) updating the first file management information and the second file management information so as to correspond to a record position of the file.

8. A method according to claim 7, wherein:
at least one partition which is defined as an area accessible with the first access method and at least one segment which is defined as an area accessible with the second access method are allocated in the information recording medium; and
the data area is an overlap area in which parts of the at least one partition and the at least one segment overlap each other.

9. A method according to claim 8, wherein:
the segment includes a first segment and a second segment;
the first segment is an area in which a non-real time file for implementing a function of a predetermined application is to be recorded;
the second segment is an area in which a real time file for implementing a function of the predetermined application is to be recorded; and
the step (b) includes the steps of:
determining whether the file to be recorded is the non-real time file or the real time file;
when the file to be recorded is the non-real time file, recording the non-real time file in the first segment; and
when the file to be recorded is the real time file, recording the real time file in the second segment.

10. A method according to claim 7, wherein:
the second file management information includes record end position information which indicates a position where recording is finished; and
the step (b) includes the step of recording the file in the data area in accordance with the record end position information.

11. A method according to claim 10, wherein:
the record end position information indicates a position where one way repetitive recording is finished; and
the step (b) includes the step of repetitively recording the file in one way in the data area in accordance with the record end position information.

12. A method according to claim 7, wherein:
the second file management information includes record position information which indicates a record position of the first file management information; and
the step (c) includes the step of updating the record position information of the second file management information so as to correspond to the record position of the updated first file management information.

13. A method according to claim 7, wherein:
the first file management information includes first integrity information which indicates whether a state of the first file management information is an open state or a closed state; and
the first integrity information indicating the open state indicates that a file can be recorded in the information recording medium, and the first integrity information indicating the closed state indicates that a file is normally recorded, the method further comprising the steps of:
putting the first integrity information into the open state before the step (b); and
putting the first integrity information into the closed state after the step (b).

14. A method according to claim 7, wherein:
the second file management information includes second integrity information which indicates whether a state of the second file management information is an open state or a closed state; and
the second integrity information indicating the open state indicates that a file can be recorded in the information recording medium, and the second integrity information indicating the closed state indicates that a file is normally recorded, the method further comprising the steps of:
putting the second integrity information into the open state before the step (b); and
putting the second integrity information into the closed state after the step (b).

15. A method according to claim 7, wherein:
the first file management information includes first file name information for indicating a name of the file recorded in the data area and first record position information for indicating a record position of the file recorded in the data area; and
the second file management information includes second file name information for indicating a name of the file recorded in the data area and second record position information for indicating a record position of the file recorded in the data area, the method further comprising steps of:
determining whether the first file name information and the second file name information correspond to each other; and
determining whether the first record position information and the second record position information correspond to each other.

16. A method according to claim 1, wherein a file is recorded in the data area, and the step (b) includes the step of reproducing the file.

17. An apparatus for accessing an information recording medium in which a data area is allocated, wherein:
first file management information which provides a first access method and second file management information which provides a second access method are recorded in the information recording medium; and
the first file management information and the second file management information manage files recorded in the information recording medium, the apparatus comprising:
reading means for reading out one of the first file management information and the second file management information; and
accessing means for accessing the data area with the access method provided by one of the read out first file management information and the second file management information.

18. An apparatus according to claim 17, wherein the accessing means includes recording means for recording a file in the data area, the apparatus further comprising:
updating means for updating the first file management information and the second file management information so as to correspond to a record position of the file.

19. An apparatus according to claim 17, wherein a file is recorded in the data area, and the accessing means includes reproducing means for reproducing the file.

20. An information recording medium in which the first file management information and the second file management information are recorded, wherein:
the first file management information and the second file management information manage a file recorded in the information recording medium;
the first file management information provides the first access method to a data area allocated to the information recording medium; and
the second file management information provides the second access method to the data area.
